(19) United States
(12) Patent Application Publication
(10) Pub. No.: US 2026/0273522 A1
(43) Pub. Date: Sep. 17, 2026

(54) REACTION VESSEL AND REACTION VESSEL SYSTEM

(71) Applicant: ATTOPLEX INC., Hanam-si (KR)

(72) Inventors: In Hyuk CHUNG, Hanam-si (KR); Hyun Kyu YOON, Hanam-si (KR); Jun Ho MAENG, Hanam-si (KR); Sung Min KIM, Hanam-si (KR); Sang Yoon LEE, Namyangju-si (KR); Byoung Jun CHA, Namyangju-si (KR)

(73) Assignee: ATTOPLEX INC., Hanam-si (KR)

(21) Appl. No.: 19/168,458

(22) PCT Filed: Mar. 28, 2024
(86) PCT No.: PCT/KR2024/003930

§ 371 Date: Sep. 24, 2025

(30) Foreign Application Priority Data
May 3, 2023 (KR) 10-2023-0057933
Mar. 15, 2024 (KR) 10-2024-0036739

(51) Int. Cl. B01L 3/00; B01L 7/00

(52) U.S. Cl. CPC B01L 3/502; B01L 7/00; B01L 2300/044; B01L 2300/0627; B01L 2300/0867

(57) ABSTRACT

Provided is a reaction vessel. The reaction vessel includes a body part, a first storage part that is disposed in the body part, being movable upward and downward, and includes a first storage space in an interior thereof, a second storage part that is disposed in the body part, is movable upward and downward, including a second storage part in an interior thereof, and is disposed in a first direction that is one of leftward/rightward directions with respect to the first storage part, and a mixing part including a mixing space that communicates with the first storage space when the first storage part is located at a lowermost end thereof, and communicates with the second storage space when the second storage part is located at the lowermost end thereof.

### CROSS-REFERENCE TO RELATED APPLICATION

This application claims the benefit of priority to Korean Patent Application No. 10-2023-0057933, filed in the Korean Intellectual Property Office on May 3, 2023, and Korean Patent Application No. 10-2024-0036739, filed in the Korean Intellectual Property Office on Mar. 15, 2024, the entire contents of which are incorporated herein by reference.

The present disclosure relates to a reaction vessel and a reaction vessel system.

### TECHNICAL FIELD

### Background Art

Molecular diagnosis is a method of detecting nucleic acids (DNA, RNA, or variants thereof) of bacteria, viruses, and the like that cause diseases, to detect causes of diseases and the presence or absence of infection.

Such a molecular diagnosis process includes a pretreatment process for obtaining pure DNA or RNA from animal cells, plant cells, bacteria, viruses, and the like, a target gene amplification process of DNA or RNA, and a process of detecting causes of diseases and the presence or absence of infection by analyzing amplification products.

That is, to detect causes of diseases or the presence or absence of infection by using an extremely small amount of a gene, the gene needs to be amplified, and among various techniques, a polymerase chain reaction (PCR) is a technique capable of exponentially amplifying genetic material having a specific nucleotide sequence of nucleic acids by repeatedly heating and cooling the genetic material to sequentially replicate a region having the specific nucleotide sequence.

Furthermore, an isothermal amplification method that is capable of sequentially replicating and amplifying a region having a specific nucleotide sequence of nucleic acids at a constant temperature may also be applied.

Recently, devices that allow individuals to determine the presence or absence of infection by performing a gene amplification reaction and a detection process on their own through a container in the form of a kit or a cartridge have been developed.

Conventional inspection devices have all components used for inspection separated from each other, making the use process complicated, and the number of use steps is large, thereby increasing the probability of variations in results depending on the user.

Furthermore, in each operation, the sample is exposed to an external environment, thereby raising a concern that contamination of the sample may occur.

### DISCLOSURE

### Technical Problem

An aspect of the present disclosure provides a reaction vessel that may be used simply, and by which a risk of contamination is reduced.

### Technical Solution

According to an aspect of the present disclosure, a reaction vessel includes a body part, a first storage part that is disposed in the body part, being movable upward and downward, and includes a first storage space in an interior thereof, a second storage part that is disposed in the body part, being movable upward and downward, includes a second storage part in an interior thereof, and is disposed in a first direction being one of leftward/rightward directions with respect to the first storage part, a mixing part including a mixing space that communicates with the first storage space when the first storage part is located at a lowermost end thereof, and communicates with the second storage space when the second storage part is located at the lowermost end thereof, and a reaction detection part that reacts with a reaction mixture located in the mixing space to exhibit a detection reaction after the lower end portion contacts the reaction mixture.

In another example, the first storage part may include a first storage part body that defines the first storage space that is opened upward and downward, and a first lower cover that is coupled to a lower side of the first storage part body and covers a lower side of the first storage space, the mixing part may include a first rupturing member that defines a first introduction space communicating with the mixing space and extends to an upper side of the mixing space, and the first rupturing member may rupture the first lower cover when the first storage part is moved downward to allow the first storage space and the first introduction space to communicate with each other.

In another example, the first storage part may further include a first storage part body that defines the first storage space that is opened upward and downward, and a first upper cover that is coupled to an upper side of the first storage part body and opens and closes an upper side of the first storage space.

In another example, an upper side of the first storage part body may be formed to be inclined upward with respect to the first direction, and the first upper cover may have a shape corresponding to the upper side of the first storage part body.

In another example, the first upper cover may be coupled to the upper side of the first storage part body to be slid leftward and rightward, may open the upper side of the first storage space when being moved in a second direction opposite to the first direction, and may close the upper side of the first storage space when being moved in the first direction.

In another example, the second storage part may include a second storage part body that defines the second storage space that is opened upward and downward, and a second lower cover that is coupled to a lower side of the second storage part body and covers a lower side of the second storage space, the mixing part may include a second rupturing member that defines a second introduction space that communicates with the mixing space and extends to the upper side of the mixing space, and the second rupturing member may rupture the second lower cover when the second storage part is moved downward to allow the second storage space and the second introduction space to communicate with each other.

In another example, the second storage part may further include an opening that is formed at an upper portion of the second storage part body, and an opening cover that closes the opening, and the body part may include an opening rupturing member that ruptures the opening cover to open the opening when the second storage part is moved downward.

In another example, the opening may be formed in a side wall of the second storage part body, the opening rupturing member may contact a lower surface of an area of the second storage part body that defines the opening to support the second storage part body upward, a surface of the opening rupturing member that contacts the second storage part body may be formed to be an inclined surface, and when the second storage part body is moved downward, an end of the opening rupturing member that faces the second storage part body may be moved to contact the second storage part body so as to contact the opening cover after elastically supporting the second storage part body.

In another example, the body part may further include a communication opening that is formed in a wall corresponding to a position of the opening when the second storage part body is moved downward, and the opening rupturing member may be disposed in the communication opening.

In another example, the first storage part may include a first storage part body that defines the first storage space that is opened upward and downward, and a stopper opening that is formed in the first storage part body and is opened upward, and the second storage part may include a second storage part body that defines the second storage space that is opened upward and downward, and a stopper member that protrudes from the second storage part body and passes through the stopper opening.

In another example, the reaction detection part may be connected to the second storage part by the stopper member to be moved upward and downward, and may be disposed in a second direction of the first storage part that is opposite to the first direction.

In another example, the body part may include a first guide opening that is formed in a side wall of the body part in a third direction that is perpendicular to the upward/downward directions and the first direction, and a second guide opening that is located in the first direction of the first guide opening and that is opened upward, the first storage part may include a first storage part body that defines the first storage space that is opened upward and downward, and a first guide projection that protrudes from the first storage part body in the third direction and is inserted into the first guide opening, and the second storage part may include a second storage part body that defines the second storage space that is opened upward and downward, and a second guide projection that protrudes from the second storage part body in the third direction and is inserted into the second guide opening.

In another example, the first guide opening may include a first interference area that has a width smaller than a diameter of the first guide projection, and interferes with downward movement of the first guide projection, the second guide opening may include a second interference area that has a width smaller than a diameter of the second guide projection, and interferes with downward movement of the second guide projection.

In another example, an operation preventing opening that is opened upward may be formed in a side wall of the body part, the first storage part may include a first storage part body that defines the first storage space that is opened upward and downward, and an operation preventing member that protrudes from the first storage part body and is seated in the operation preventing opening, and the operation preventing member may include a first part that protrudes from the first storage part body toward the side wall of the body part, and a second part that protrudes downward from the first part and is seated in the operation preventing opening.

In another example, a surface of the mixing part that defines a lower side of the mixing space may be formed to be inclined upward with respect to the first direction.

In another example, a freeze-dried buffer solution may be disposed in the mixing space, a reaction solution that reacts with a sample sampled from a user may be disposed in the first storage space, a developer solution that develops the reaction solution mixed with the buffer solution to the reaction detection part may be disposed in the second storage space, and the buffer solution may include an enzyme and a primer.

According to an aspect of the present disclosure, a reaction vessel system includes a reaction vessel, and a heating device that is configured such that the reaction vessel is inserted into an insertion space in an interior thereof, and heats a lower side of the reaction vessel, and the reaction vessel includes a body part, a first storage part that is disposed in the body part, is movable upward and downward, and includes a first storage space in an interior thereof, a second storage part that is disposed in the body part, being movable upward and downward, and includes a second storage space in an interior thereof, a mixing part including a mixing space that communicates with the first storage space when the first storage part is located at a lowermost end thereof, and communicates with the second storage space when the second storage part is located at the lowermost end thereof.

In another example, the heating device may include a heating part that heats the mixing space while contacting a lower side of the mixing part, and a first switch that is pressed by a lower side of the reaction vessel to operate the heating part when the reaction vessel is inserted into the insertion space.

In another example, an operation preventing opening that is opened upward may be formed in a side wall of the body part, the first storage part may include a first storage part body that defines the first storage space that is opened upward and downward, and an operation preventing member that protrudes from the first storage part body and is seated in the operation preventing opening, the operation preventing member may include a first part that protrudes from the first storage part body toward the side wall of the body part, and a second part that protrudes downward from the first part and is seated in the operation preventing opening, and the heating device may include an operation initiating projection that protrudes from a surface that defines the insertion space toward the second part, and presses the second part to separate the second part from the operation preventing opening when the reaction vessel is moved downward.

In another example, the body part may include a first operation opening that is opened upward, and a second operation opening that is opened upward, the first storage part may include a first storage part body that defines the first storage space that is opened upward and downward, and a first operation projection that is inserted into the first operation opening and protrudes from the first storage part body to pass through the first operation opening, the second storage part may include a second storage part body that defines the second storage space that is opened upward and downward, and a second operation projection that is inserted into the second operation opening and protrudes from the second storage part body to pass through the second operation opening, and the heating device may include a signal generator that generates a specific signal to a user, a second switch that is disposed at a position corresponding to the first operation projection, and operates the signal generator such that the signal generator generates the signal after a first reference time period when being pressed by the first operation projection, and a third switch that is disposed at a position corresponding to the second operation projection, and operates the signal generator such that the signal generator generates the signal after a second reference time period when being pressed by the second operation projection.

According to an aspect of the present disclosure, a reaction vessel includes a body part, a first storage part that is disposed in the body part, being movable upward and downward, and includes a first storage space in an interior thereof, a second storage part that is disposed in the body part, is movable upward and downward, including a second storage part in an interior thereof, and is disposed in a first direction that is one of leftward/rightward directions with respect to the first storage part, and a mixing part including a mixing space that communicates with the first storage space when the first storage part is located at a lowermost end thereof, and communicates with the second storage space when the second storage part is located at the lowermost end thereof, and the mixing part includes a first inclined portion that is formed to be inclined upward with respect to the first direction, and a second inclined portion that is formed to be inclined upward with respect to the first direction and is located in the first direction of the first inclined portion, and an inclination degree of which is smaller than that of the first inclined portion.

In another example, when viewed along upward/downward direction, the first inclined portion may include an area that overlaps the first storage part, and the second inclined portion may include an area that overlaps the second storage part.

In another example, the first storage part may include a first storage part body that defines the first storage space that is opened upward and downward, and a first lower cover that is coupled to a lower side of the first storage part body and covering a lower side of the first storage space, the mixing part may include a first rupturing member that defines a first introduction space that communicates with the mixing space and extends to an upper side of the mixing space, and the first rupturing member may rupture the first lower cover when the first storage part is moved downward to allow the first storage space and the first introduction space to communicate with each other.

In another example, the first storage part may further include a first interference part that protrudes from an inner surface of the first storage part body toward the first storage space, and interferes with an entry of a sampling tool that is introduced into the first storage space.

In another example, the first storage space may include an upper space that is located on an upper side of the first interference part, and a lower space that is located on a lower side of the first interference part, and a length of the upper space in upward/downward directions may be smaller than a length of the lower space in the upward/downward directions.

In another example, the second storage part may include a second storage part body that defines the second storage space that is opened upward and downward, and a second lower cover that is coupled to a lower side of the second storage part body and covers a lower side of the second storage space, the mixing part may include a second rupturing member that defines a second introduction space that communicates with the mixing space and extends to the upper side of the mixing space, and the second rupturing member may rupture the second lower cover when the second storage part is moved downward to allow the second storage space and the second introduction space to communicate with each other.

In another example, the second storage part may further include an opening that is formed at an upper portion of the second storage part body, and an opening cover that closes the opening, and the body part may include an opening rupturing member that ruptures the opening cover when the second storage part is moved downward.

In another example, the opening may be formed in a side wall of the second storage part body and may have a shape inclined upward with respect to the first direction, and when viewed along the upward/downward direction, an end of the opening rupturing member and the opening cover may overlap each other.

In another example, an end of the opening rupturing member may face an upper side.

In another example, the first storage part may further include a first stopper opening that is formed in the first storage part body, is opened upward, and is opened along the first direction, and the second storage part may include a stopper member that protrudes from the second storage part body, and passes through the first stopper opening along an opposite direction of the first direction.

In another example, a second stopper opening that is opened downward and opened along a direction that is perpendicular to the first direction may be formed in the stopper member, and at least any one of when the first storage part and the second storage part are located at an uppermost end or the first storage part and the second storage part are located at a lowermost end, an area of the first storage part body that defines the first stopper opening and an area of the stopper member that defines the second stopper opening may be engaged with each other.

In another example, the reaction vessel may further include a reaction detection part that reacts with a reaction mixture located in the mixing space to exhibit a detection reaction after the lower end portion contacts the reaction mixture, and the reaction detection part may be formed in a fitting area of the first storage part of the stopper member that is located in a second direction that is opposite to the first direction, and an upper end portion thereof may be fitted in a fitting opening that is opened downward.

In another example, the fitting area may further include a disposition opening that is opened toward the second direction, and in which the reaction detection part is disposed in an interior thereof.

In another example, the body part may further include a through portion that is opened upward and downward, and surrounds a portion of the reaction detection part.

In another example, the body part may include a first operation opening that is opened upward, and a second operation opening that is opened upward and located in the first direction of the first operation opening, the first storage part may include a first storage part body that defines the first storage space that is opened upward and downward, a first operation projection that is inserted into the first operation opening and that protrudes from the first storage part body to pass through the first operation opening, and a first magnet that is coupled to an end of the first operation projection, and the second storage part may include a second storage part body that defines the second storage space that is opened upward and downward, a second operation projection that is inserted into the second operation opening and that protrudes from the second storage part body to pass through the second operation opening, and a second magnet that is coupled to an end of the second operation projection,

In another example, the reaction vessel may further include an operation projection that protrudes downward from a lower surface of the mixing part, and an operation magnet that is coupled to an end of the operation projection.

In another example, the mixing part may further include a mixing opening that communicates the mixing space, is located in an opposite direction of the first direction of the first inclined portion, and is opened upward.

According to an aspect of the present disclosure, a reaction vessel system includes a reaction vessel, and a heating device that is configured such that the reaction vessel is inserted into an insertion space in an interior thereof, and heats a lower side of the reaction vessel, the reaction vessel includes a body part, a first storage part that is disposed in the body part, is movable upward and downward, and includes a first storage space in an interior thereof, a second storage part that is disposed in the body part, being movable upward and downward, includes a second storage part in an interior thereof, and is disposed in a first direction that is one of leftward/rightward directions with respect to the first storage part, and a mixing part including a mixing space that communicates with the first storage space when the first storage part is located at a lowermost end thereof, and communicates with the second storage space when the second storage part is located at the lowermost end thereof, and the mixing part includes a first inclined portion that is formed to be inclined upward with respect to the first direction, and a second inclined portion that is formed to be inclined upward with respect to the first direction and is located in the first direction of the first inclined portion, and an inclination degree of which is smaller than that of the first inclined portion.

In another example, the reaction vessel system may further include an operation projection that protrudes downward from a lower surface of the mixing part, and an operation magnet that is coupled to an end of the operation projection, the mixing part may include a mixing opening that communicates the mixing space, is located in an opposite direction of the first direction of the first inclined portion, and is opened upward, and the heating device may include a heating part that contacts an area of the mixing part that defines the mixing opening and heats the mixing opening, and a first sensing member senses the operation magnet when the reaction vessel is inserted into the insertion space.

In another example, the body part may include a first operation opening that is opened upward, and a second operation opening that is opened upward and is located in the first direction of the first operation opening, the first storage part may include a first storage part body that defines the first storage space that is opened upward and downward, a first operation projection that is inserted into the first operation opening and protrudes from the first storage part body to pass through the first operation opening, and a first magnet that is coupled to an end of the first operation projection, the second storage part may include a second storage part body that defines the second storage space that is opened upward and downward, a second operation projection that is inserted into the second operation opening and that protrudes from the second storage part body to pass through the second operation opening, and a second magnet that is coupled to an end of the first operation projection, the heating device may further include a signal generator that generates a specific signal to a user, a second sensing member that is disposed at a position corresponding to the first operation projection, and operates the signal generator to generate the signal after a first reference time period when detecting the first magnet, and a third sensing member that is disposed at a position corresponding to the second operation projection, and operates the signal generator to generate the signal after a second reference time period when detecting the second magnet.

### Advantageous Effects

According to the present disclosure, components that are necessary for detection of a sample are disposed in a single reaction vessel, so that use is simplified and a risk of contamination may be reduced.

### DESCRIPTION OF DRAWINGS

FIG. 1 is a perspective view illustrating a reaction vessel according to a first embodiment of the present disclosure.

FIG. 2 is a view illustrating the reaction vessel of FIG. 1, viewed from a different direction.

FIG. 3 is an exploded perspective view illustrating the reaction vessel according to the first embodiment of the present disclosure.

FIG. 4 is a view illustrating the reaction vessel according to the first embodiment of the present disclosure, viewed from a third direction.

FIG. 5 is a view illustrating the reaction vessel according to the first embodiment of the present disclosure, viewed from a fourth direction.

FIG. 6 is a cross-sectional view illustrating the reaction vessel according to the first embodiment of the present disclosure.

FIG. 7 is a cross-sectional view illustrating a first upper cover.

FIG. 8 is a view illustrating the first upper cover and a separation preventing member.

FIG. 9 is a view illustrating a state, in which an opening cover is ruptured by an opening rupturing member.

FIG. 10 is a cutaway perspective view of a lower portion of a reaction vessel according to the first embodiment of the present disclosure.

FIG. 11 is a view illustrating a state, in which a first storage part is moved downward in FIG. 10.

FIG. 12 is a view illustrating a state, in which a second storage part is moved downward in FIG. 11.

FIG. 13 is a conceptual view illustrating an operation of a reaction vessel.

FIG. 14 is a view illustrating a stopper opening and a stopper member.

FIG. 15 is a view illustrating a heating device according to the first embodiment of the present disclosure.

FIG. 16 is a view illustrating a heating device according to the first embodiment of the present disclosure, viewed from a top.

FIG. 17 is a perspective view illustrating a reaction vessel according to a second embodiment of the present disclosure.

FIG. 18 is a view illustrating the reaction vessel of FIG. 17, viewed from a different direction.

FIG. 19 is an exploded perspective view illustrating the reaction vessel according to the second embodiment of the present disclosure.

FIG. 20 is a perspective view illustrating a swab

FIG. 21 is a cross-sectional view illustrating a state, in which a swab is disposed in a first inner space of the reaction vessel according to the second embodiment of the present disclosure.

FIG. 22 is a view illustrating a second storage part of the reaction vessel according to the second embodiment of the present disclosure.

FIG. 23 is a view illustrating the second storage part of FIG. 22, viewed from a different direction.

FIG. 24 is a view illustrating a first stopper opening and a second stopper opening together

FIG. 25 is a view illustrating a state before the first storage part and the second storage part are moved downward.

FIG. 26 is a view illustrating a state, in which a first storage part is moved downward in FIG. 25.

FIG. 27 is a view illustrating a state in which the second storage part is moved downward in FIG. 26.

FIG. 28 is a view illustrating a heating device according to the second embodiment of the present disclosure.

FIG. 29 is a view illustrating a heating device according to the second embodiment of the present disclosure, viewed from a top.

FIG. 30 is a view illustrating a state, in which the reaction vessel is disposed in an interior of the heating device according to the second embodiment of the present disclosure.

FIG. 31 is a view sequentially illustrating operation procedures of a reaction vessel system according to the second embodiment of the present disclosure.

### MODE FOR INVENTION

Hereinafter, some embodiments of the present disclosure will be described in detail with reference to the accompanying drawings. In adding reference numerals to components of each drawing, it should be noted that the same components have the same reference numerals, although they are indicated on another drawing. Furthermore, in describing embodiments of the present disclosure, detailed descriptions associated with well-known functions or configurations will be omitted if they may make subject matters of the present disclosure unnecessarily obscure.

Hereinafter, a reaction vessel and a reaction vessel system will be described in detail. The reaction vessel system may include a reaction vessel and a heating device. The reaction vessel may be a vessel for performing a PCR reaction and a reaction detection. The heating device may be configured such that the reaction vessel is inserted into an insertion space in an interior thereof, and may be configured to heat a lower portion of the reaction vessel. The insertion space may be opened upward.

### First Embodiment

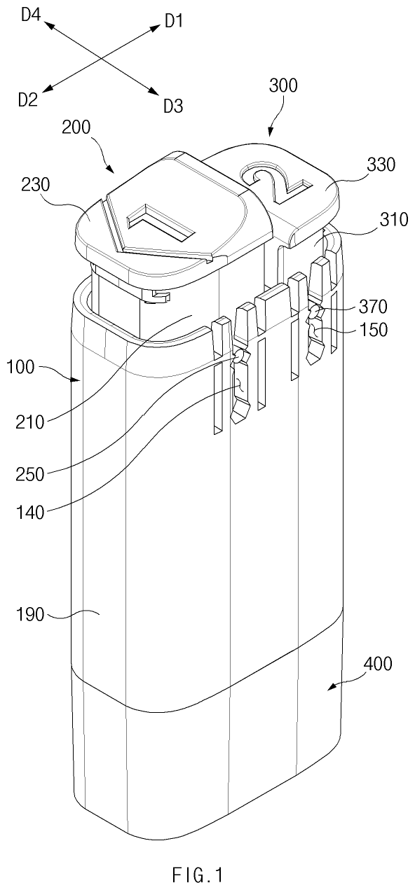

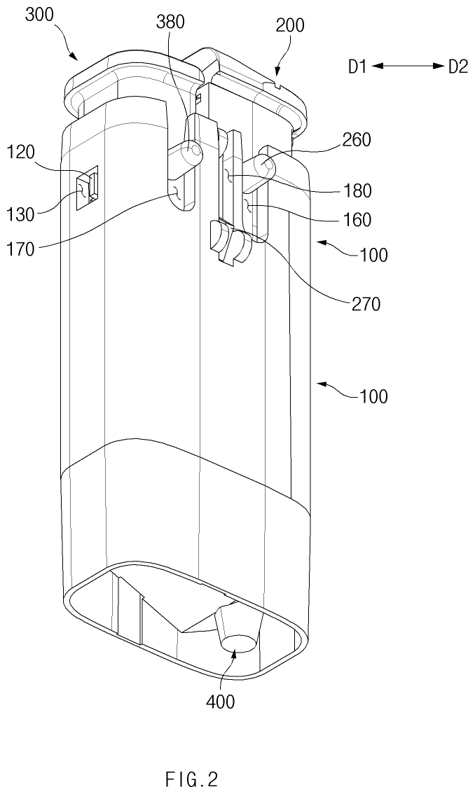

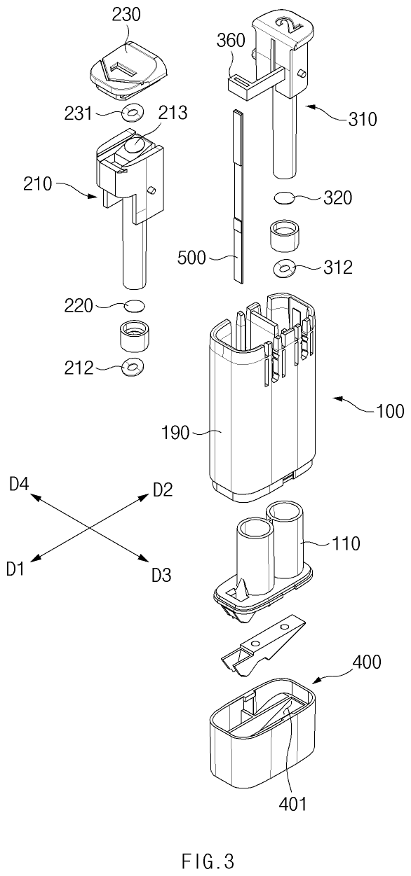

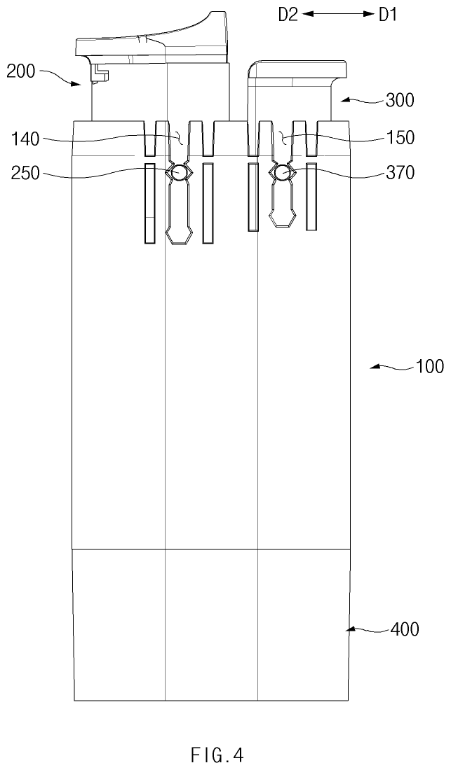

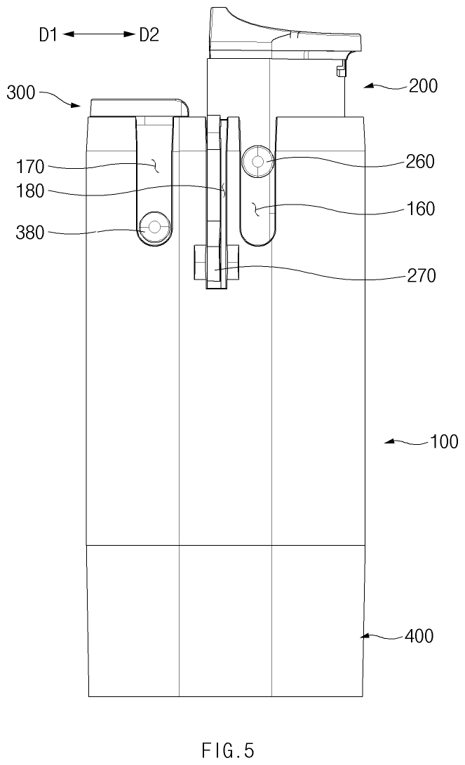

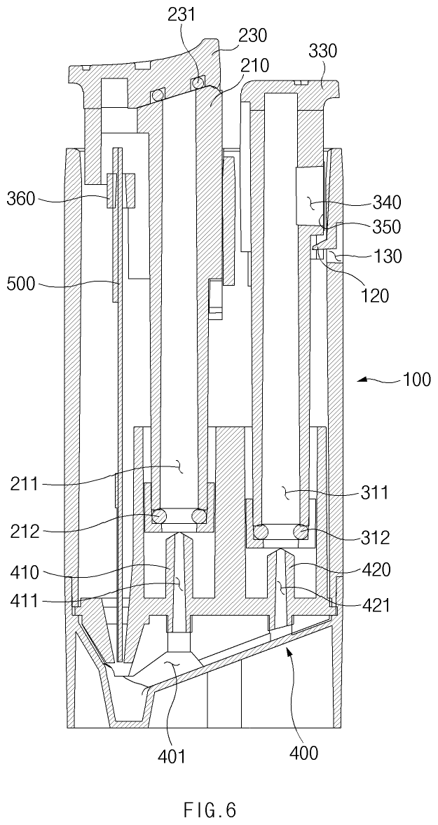

Hereinafter, a reaction vessel according to the first embodiment will be described first in detail. FIG. 1 is a perspective view illustrating a reaction vessel according to a first embodiment of the present disclosure. FIG. 2 is a view illustrating the reaction vessel of FIG. 1, viewed from a different direction. FIG. 3 is an exploded perspective view illustrating the reaction vessel according to the first embodiment of the present disclosure. FIG. 4 is a view illustrating the reaction vessel according to the first embodiment of the present disclosure, viewed from a third direction D3. FIG. 5 is a view illustrating the reaction vessel according to the first embodiment of the present disclosure, viewed from a fourth direction D4. FIG. 6 is a cross-sectional view illustrating the reaction vessel according to the first embodiment of the present disclosure.

Hereinafter, a first direction D1 is defined as a direction, in which a first storage part 200 that will be described later faces a second storage part 300 that will be described later, among leftward/rightward directions, and an opposite direction thereof is defined as a second direction D2. The second storage part 300 may be a component, in which a developer solution is stored. Furthermore, a direction that is perpendicular to upward/downward directions and the first direction D1 is defined as a third direction D3, and an opposite direction thereof is defined as a fourth direction D4.

### Reaction Vessel

The reaction vessel according to the first embodiment of the present disclosure may include a body part 100, a first storage part 200, a second storage part 300, a mixing part 400, and a reaction detection part 500. The body part 100 may include a guide member 110 that guides upward/downward movements of the first storage part 200 and the second storage part 300. The guide member 110 may include an area that extends upward and downward and, in which the first storage part 200 and the second storage part 300 are disposed in an interior thereof.

Furthermore, the body part 100 may include an exposure area 190 for exposing the reaction detection part 500 to the outside. As an example, the exposure area 190 may be formed of a transparent material, and may also be formed as an opening.

The first storage part 200 may be disposed in the body part 100 and may be movable in the upward/downward directions. The first storage part 200 may include a first storage space 211 in an interior thereof. The first storage part 200 may be a component, in which a reaction solution that is configured to react with a sample sampled from a user is stored. Furthermore, a sampling tool, on which a sample sampled by a user is applied, may be introduced into the first storage part 200. The sampling tool may be a swab, but the present disclosure is not limited thereto.

The second storage part 300 may be disposed in the body part 100, may be movable in the upward/downward directions, and may include a second storage space 311 in an interior thereof. The second storage part 300 may be disposed in a first direction D1 that is one of leftward/rightward directions with respect the first storage part 200.

The mixing part 400 may include a mixing space 401. The mixing part 400 may be disposed on a lower side of the first storage part 200 and the second storage part 300. The mixing space 401 may communicate with the first storage space 211 when the first storage part 200 is located at a lowermost end, and may communicate with the second storage space 311 when the second storage part 300 is located at the lowermost end. A buffer solution may be disposed in the mixing space 401. The buffer solution may be stored in a frozen state. The buffer solution may include an enzyme and a primer.

A portion of a surface of the mixing part 400 that defines a lower side of the mixing space 401 may be formed to be inclined upward with respect to the first direction D1. This may be a structure for moving a reaction solution, a developer solution, and the like through the inclination.

The reaction detection part 500 may be configured such that a lower end portion thereof contacts a reaction mixture located in the mixing space 401 at a lower end portion thereof and reacts with the reaction mixture to exhibit a detection reaction. The reaction detection part 500 may be a Lateral Flow Assay (LFA). As an example, the reaction detection part 500 may be connected to the second storage part 300 and may be operated in association with a movement of the second storage part 300.

In summary, a freeze-dried buffer solution may be disposed in the mixing space 401, a reaction solution that is configured to react with the sample sampled from a user may be disposed in the first storage space 211, and a developer solution that is configured to develop the reaction solution mixed with the buffer solution to the reaction detection part 500 may be disposed in the second storage space 311.

According to the present disclosure, the first storage part 200, the second storage part 300, and the mixing part 400 that are required for detecting a sample may be disposed in a single body, so that usage may be simplified and a risk of contamination may be reduced. Hereinafter, detailed structures of the device will be described.

The first storage part 200 may include a first storage part body 210 and a first lower cover 220. The first storage part body 210 may define a first storage space 211. The first storage space 211 may be opened upward and downward. An upper side of the first storage space 211 may be covered by a first storage space upper cover 213. The first storage space upper cover 213 may be made of a material that may be ruptured. As an example, the first storage space upper cover 213 may be a silver foil seal.

The first lower cover 220 may be coupled to a lower side of the first storage part body 210 to cover a lower side of the first storage space 211. The first lower cover 220 may be made of a material that may be ruptured. As an example, the first lower cover 220 may be a silver foil seal.

The mixing part 400 may include a first rupturing member 410. The first rupturing member 410 may define a first introduction space 411. The first introduction space 411 may communicate with the mixing space 401 and may extend upward from the mixing space 401. The first introduction space 411 may be a space that allows the first inner space and the mixing space 401 to communicate with each other. The first rupturing member 410 may pierce the first lower cover 220 when the first storage part 200 is moved downward, so that the first storage space 211 and the first introduction space 411 may communicate with each other.

A first lower sealing member 212 may be disposed at a lower side of the first storage space 211. The first lower sealing member 212 may be an O-ring. The first rupturing member 410 may be inserted into the first lower sealing member 212. As the first rupturing member 410 is inserted into the first lower sealing member 212, leakage of the contents of the first storage space 211 into a space other than the first introduction space 411 may be prevented when the first lower cover 220 is ruptured.

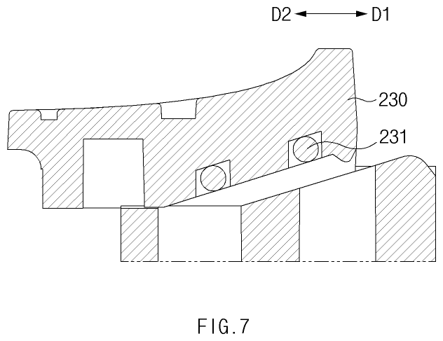

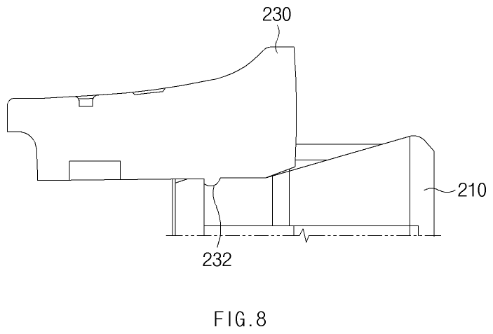

FIG. 7 is a cross-sectional view illustrating a first upper cover 230. FIG. 8 is a view illustrating the first upper cover 230 and a separation preventing member 232. The first storage part 200 may further include the first upper cover 230. The first upper cover 230 may be coupled to an upper side of the first storage part body 210 to open and close an upper side of the first storage space 211.

As an example, the first upper cover 230 may be coupled to an upper side of the first storage part body 210 to be slidable leftward and rightward. The first upper cover 230 may open an upper side of the first storage space 211 when being moved in the second direction D2, and may close the upper side of the first storage space 211 when being moved in the first direction D1.

The first upper cover 230 may include a first upper sealing member 231 for maintaining airtightness. As an example, the first upper sealing member 231 may be an O-ring. Furthermore, the first upper cover 230 may include a separation preventing member 232 that protrudes downward to prevent separation during sliding movement thereof. The separation preventing member 232 may be stopped by the first storage part body 210 when the first upper cover 230 is moved in the second direction D2.

An upper side of the first storage part body 210 may be formed to be inclined upward with respect to the first direction D1, and the first upper cover 230 may have a shape corresponding to the upper side of the first storage part body 210. Because the upper side of the first storage part body 210 has an inclined shape, the upper side of the first storage part body 210 and the first upper cover may contact each other well even only by leftward and rightward sliding movement. Accordingly, an effect of sealing an upper side of the first storage space 211 may be obtained.

The second storage part 300 may include a second storage part body 310 and a second lower cover 320. The second storage part body 310 may define a second storage space 311. The second storage space 311 may be opened upward and downward.

The second lower cover 320 may be coupled to a lower side of the second storage part body 310 to cover a lower side of the second storage space 311. The second lower cover 320 may be made of a material that may be ruptured. As an example, the second lower cover 320 may be a silver foil seal.

The mixing part 400 may include a second rupturing member 420. The second rupturing member 420 may define a second introduction space 421. The second introduction space 421 may communicate with the mixing space 401 and may extend upward from the mixing space 401. The second introduction space 421 may be a space that allows the second inner space and the mixing space 401 to communicate with each other.

The second rupturing member 420 may pierce the second lower cover 320 when the second storage part 300 is moved downward, so that the first storage space 211 and the second introduction space 421 may communicate with each other.

A second lower sealing member 312 may be disposed at a lower side of the second storage space 311. The second lower sealing member 312 may be an O-ring. The second rupturing member 420 may be inserted into the second lower sealing member 312. As the second rupturing member 420 is inserted into the second lower sealing member 312, leakage of the contents of the first storage space 211 into a space other than the second introduction space 421 may be prevented when the second lower cover 320 is ruptured.

The second storage part 300 may include a second upper cover 330. The second upper cover 330 may be located on an upper side of the second storage part body 310. The second upper cover 330 may be formed integrally with the second storage part body 310.

The second storage part 300 may further include an opening 340 and an opening cover 350. The opening 340 may be formed at an upper portion of the second storage part body 310. The opening 340 may be formed in a side wall of the second storage part body 310. As an example, the opening 340 may be formed in a side wall of the second storage part body 310 in the first direction D1.

The opening cover 350 may be configured to close the opening 340. The opening cover 350 may be formed of a material that may be ruptured. As an example, the opening cover 350 may be a silver foil seal.

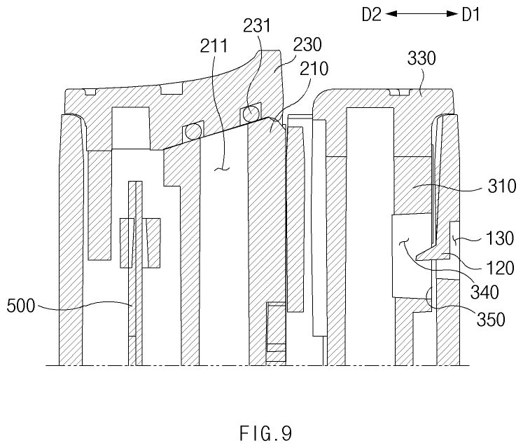

FIG. 9 is a view illustrating a state, in which the opening cover 350 is ruptured by an opening rupturing member 120. The body part 100 may include an opening rupturing member 120. The opening rupturing member 120 may rupture the opening cover 350 to open the opening 340 when the second storage part 300 is moved downward. As an example, the opening rupturing member 120 may rupture the opening cover 350 through a restoring force by elasticity.

The opening rupturing member 120 may contact a lower surface of an area of the second storage part body 310 that defines the opening 340, and may support the second storage part body 310 upward. Furthermore, a surface of the opening rupturing member 120 that contacts the second storage part body 310 may be formed as an inclined surface. The inclined surface may be inclined upward with respect to the first direction D1.

The opening rupturing member 120 may be moved such that an end thereof that faces the second storage part body 310 contacts the second storage part body 310 when the second storage part body 310 is moved downward. This may be understood as the second storage part body 310 pressing the inclined surface downward to push the opening rupturing member 120 in the first direction D1. An end of the opening rupturing member 120 may contact the second storage part body 310, and may contact the opening cover 350 after elastically supporting the second storage part body 310. Because the opening rupturing member 120 may apply a restoring force to the opening cover 350, the opening cover 350 may be ruptured.

The body part 100 may include an opening rupturing member 120. The communication opening 130 may be formed in a wall that corresponds to a position of the opening when the second storage part 300 is moved downward. The opening rupturing member 120 may be disposed in the communication opening 130.

Based on the above-described contents, because the opening 340 is opened when the second storage part 300 is moved downward, the second storage part 300 may form the second storage space 311 as an open space when the second storage part 300 is moved downward, whereas the first storage part 200 may form the first storage space 211 as a closed space when the first storage part 200 is moved downward. However, a person skilled in the art may, as necessary, form both the first storage space 211 and the second storage space 311 as open spaces or as closed spaces, or form the first storage space 211 as an open space and the second storage space 311 as a closed space.

Because the first storage space 211 is a closed space, in the case of the first storage part 200, an amount of reaction solution corresponding to a volume of the first rupturing member 410 that is disposed in the first storage space 211 may be moved to the mixing space 401.

Because the second storage space 311 is an open space, in the case of the second storage part 300, the developer solution may be moved to the mixing space 401 until a height of the developer solution inside matches a length of the second rupturing member 420 located in the second storage space 311 in the upward/downward directions.

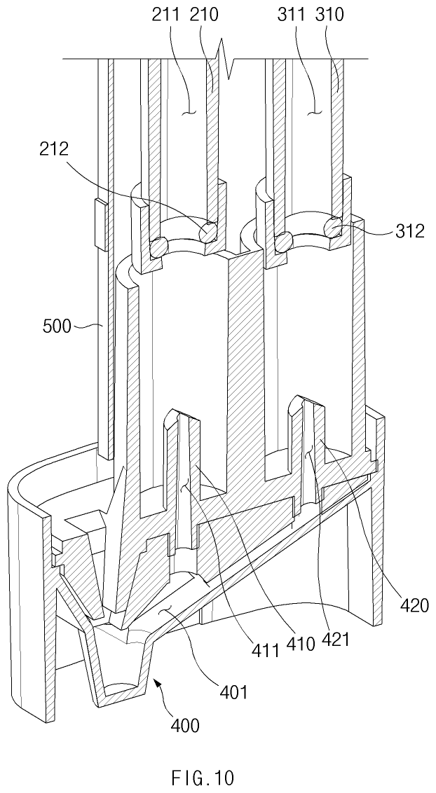

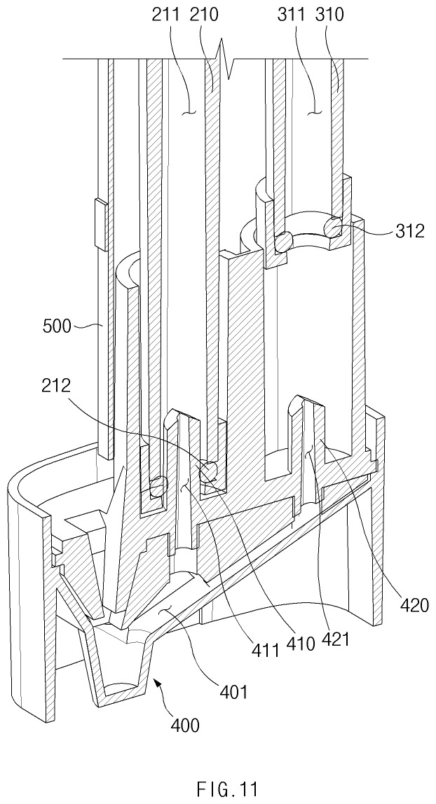

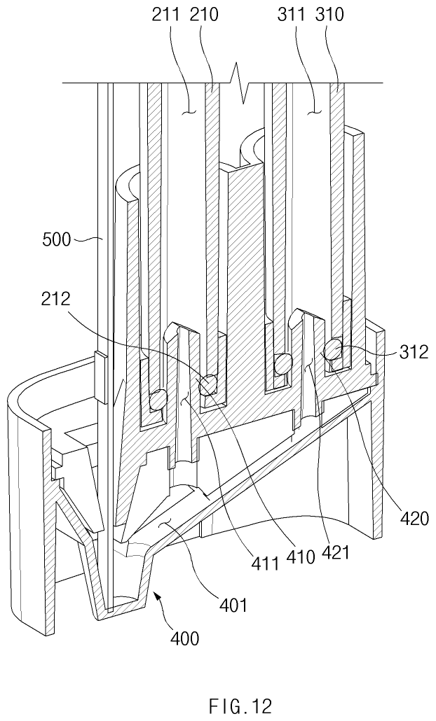

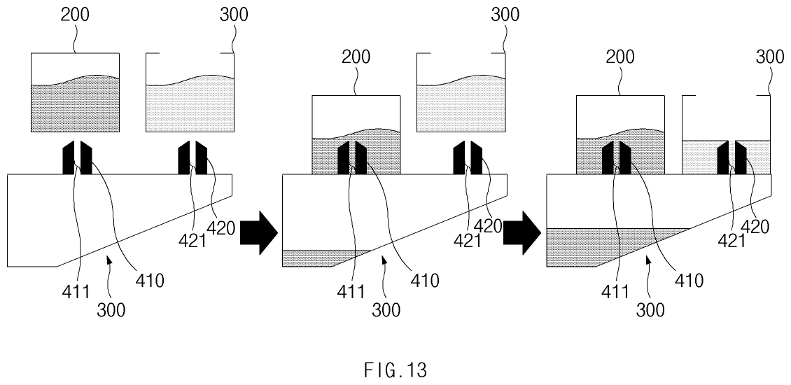

FIG. 10 is a cutaway perspective view of a lower portion of a reaction vessel according to the first embodiment of the present disclosure. FIG. 11 is a view illustrating a state, in which a first storage part 200 is moved downward in FIG. 10. FIG. 12 is a view illustrating a state, in which a second storage part 300 is moved downward in FIG. 11. FIG. 13 is a conceptual view illustrating an operation of a reaction vessel.

Hereinafter, the operation of the reaction vessel according to the first embodiment of the present disclosure will be described conceptually with reference to the above description and the drawings.

First, a user samples a sample by using a sampling tool, moves the first upper cover 230 in the second direction D2, and inserts the sampling tool into the first storage space 211. In this process, the first storage space upper cover 213 may be ruptured. The sample may react with the reaction solution.

Next, the user moves the first storage part 200 downward. In this process, the first lower cover 220 is ruptured, and the reaction solution in the first storage space 211 and the sample are moved to the mixing space 401. In this process, the buffer solution in the mixing space 401, the reaction solution, and the sample may be mixed.

Next, the user moves the second storage part 300 downward. In this process, the second lower cover 320 and the opening cover 350 are ruptured, the developer solution in the second storage space 311 is moved to the mixing space 401, and additional developer solution is introduced into the mixing space 401 so that a reaction mixture may be formed. In this process, the reaction detection part 500 is moved downward together with the second storage part 300, so that the reaction detection part 500 contacts the reaction mixture located in the mixing space 401 whereby a reaction may be detected.

As an example, the above-described operations may be performed after the reaction vessel is inserted into an insertion space 11 of the heating device 10.

Meanwhile, for the operation, movement of the first storage part 200 has to precede movement of the second storage part 300. Hereinafter, a structure for causing the movement of the first storage part 200 to precede the movement of the second storage part 300 will be described in detail.

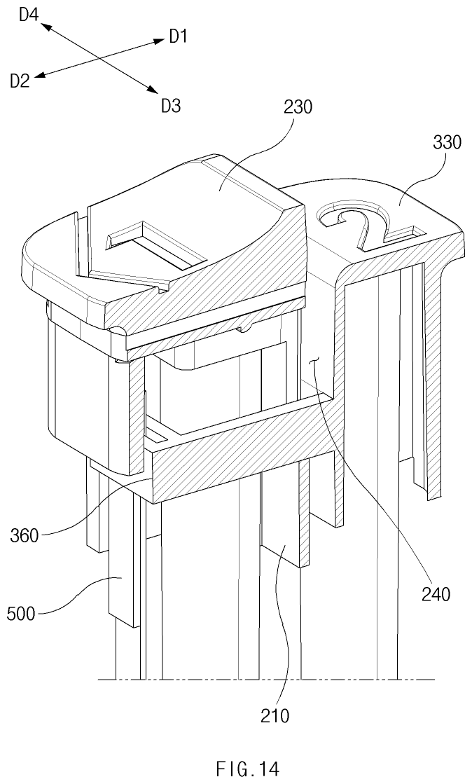

FIG. 14 is a view illustrating a stopper opening 240 and a stopper member 360. The first storage part 200 may include a stopper opening 240. The stopper opening 240 may be formed in the first storage part body 210 and may be opened upward. As an example, the stopper opening 240 may be formed at an upper portion of the first storage part body 210.

The second storage part 300 may include a stopper member 360. The stopper member 360 may protrude from the second storage part body 310 and may pass through the stopper opening 240. As an example, the reaction detection part 500 may be connected to the second storage part 300 by the stopper member 360, and may be movable upward and downward. In this case, the reaction detection part 500 may be disposed in the second direction D2 of the first storage part 200. However, this is merely an example, and it may also be possible that the second storage part 300 and the reaction detection part 500 are connected to each other through a separate member instead of the stopper member 360.

Because the stopper member 360 passes through the stopper opening 240 that is opened upward, even if the user mistakenly moves the second storage part 300 downward first, the first storage part 200 may be moved downward together. When the downward movement of the first storage part 200 is interfered with, the downward movement of the second storage part 300 is also interfered with. However, the first storage part 200 may be moved downward independently of the second storage part 300.

Hereinafter, a structure for preventing rapid lowering when moving the first storage part 200 and the second storage part 300 upward and downward will be described in detail.

The body part 100 may include a first guide opening 140 and a second guide opening 150. The first guide opening 140 may be formed in a wall of the body part 100 in the third direction D3, and may be opened upward. The second guide opening 150 may be located in the first direction D1 of the first guide opening 140, and may be opened upward.

The first storage part 200 may include a first guide projection 250. The first guide projection 250 may protrude in the third direction D3 from the first storage part body 210 and may be inserted into the first guide opening 140. The second storage part 300 may include a second guide projection 370. The second guide projection 370 may protrude in the third direction D3 from the second storage part body 310 and may be inserted into the second guide opening 150.

The first guide opening 140 may include a first interference area. The first interference area may be an area that is formed to have a width that is smaller than a diameter of the first guide projection 250 and interferes with downward movement of the first guide projection 250. The second guide opening 150 may include a second interference area. The second interference area may be an area that is formed to have a width that is smaller than a diameter of the second guide projection 370 and interferes with downward movement of the second guide projection 370.

When the first storage part 200 and the second storage part 300 are moved, the first guide projection 250 and the second guide projection 370 are primarily stopped by the first interference area and the second interference area, and because the first storage part 200 and the second storage part 300 have to be pressed downward to move the first storage part 200 and the second storage part 300 further, rapid movement of the first storage part 200 and the second storage part 300 may be prevented.

Hereinafter, a structure for interfering with downward movement of the first storage part 200 before the reaction vessel is inserted into the heating device 10 will be described in detail.

An operation preventing opening 180 that is opened upward may be formed in a side wall of the body part 100. As an example, the operation preventing opening 180 may be formed in a side wall of the body part 100 in the fourth direction D4.

The first storage part 200 may include an operation preventing member 270. The operation preventing member 270 may protrude from the body and may be seated in the operation preventing opening 180. The operation preventing member 270 may be seated in the operation preventing opening 180 and may interfere with the downward movement of the first storage part 200.

As an example, the operation preventing member 270 may include a first part and a second part. The first part may be a portion that protrudes from the first storage part body 210 toward a side wall of the body part 100. The second part may be a portion that protrudes downward from the first part and is seated in the operation preventing opening 180. The operation preventing member 270 may have elasticity. The second part may be separated from the operation preventing opening 180 when pressed by an operation initiating projection 14 of the heating device 10 that will be described later.

Because the second part is seated in the operation preventing opening 180, the downward movement of the first storage part 200 connected to the second part may be interfered with. However, when the operation initiating projection 14 of the heating device 10 presses the second part inward, the second part may be separated from the operation preventing opening 180, and from that time, the downward movement of the first storage part 200 may be possible.

The body part 100 may include a first operation opening 160 and a second operation opening 170. The first storage part 200 may include a first operation projection 260. The second storage part 300 may include a second operation projection 380. Because these are components for operating the heating device 10, a detailed description thereof will be made after a description of the heating device 10.

### Heating Device 10

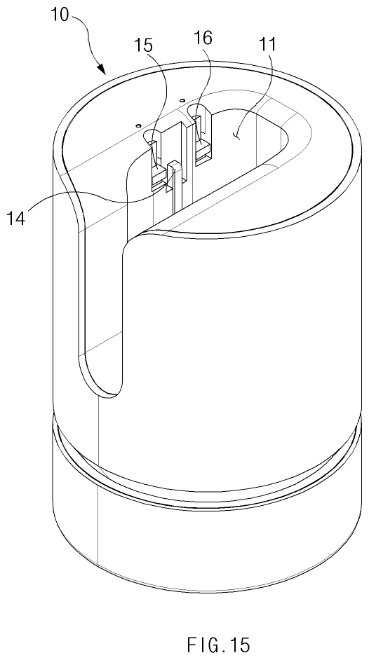

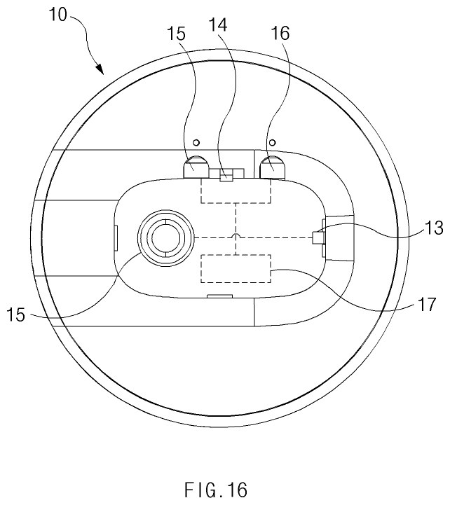

Hereinafter, the heating device 10 according to a first embodiment will be described in detail. FIG. 15 is a view illustrating a heating device 10 according to the first embodiment of the present disclosure. FIG. 16 is a view illustrating a heating device 10 according to the first embodiment of the present disclosure, viewed from a top.

The heating device 10 may include a heating part 12. The heating device 10 may contact a lower side of the mixing part 400 and may heat the mixing space 401. As an example, the heating part 12 may be operated by electric power supplied from the outside. Alternatively, the heating part 12 may be supplied with electric power through a battery embedded in the heating device 10.

The heating device 10 may include a first switch 13. When the reaction vessel is inserted into the insertion space 11, the first switch 13 may be configured to be pressed by a lower side of the reaction vessel to operate the heating part 12. As an example, the first switch 13 may be electrically connected to the heating part 12 through a controller (not illustrated). When the first switch 13 is pressed, the controller may operate the heating part 12.

The controller may include a processor and a memory. The processor may include a microprocessor, such as a field programmable gate array (FPGA), an application specific integrated circuit (ASIC), a central processing unit (CPU), and the like. The memory may store control instructions that are bases in generating instructions for determining whether the heating part 12 is operated, in the processor. The memory may be a data store such as a hard disk drive (HDD), a solid state drive (SSD), a volatile medium, a nonvolatile medium, and the like.

The heating device 10 may include an operation initiating projection 14. The operation initiating projection 14 may protrude toward the second part from a surface that defines the insertion space 11. The operation initiating projection 14 may press the second part to separate the second part from the operation preventing opening 180 when the reaction vessel is moved downward. After the operation initiating projection 14 separates the second part from the operation preventing opening 180, the user may move the first part downward.

The body part 100 may include a first operation opening 160 and a second operation opening 170. The first operation opening 160 may be opened upward. As an example, the first operation opening 160 may be formed in a side wall of the body part 100 in the fourth direction D4. The second operation opening 170 may be located in the first direction D1 of the first operation opening 160 and may be opened upward.

The first storage part 200 may include a first operation projection 260. The first operation projection 260 may be inserted into the first operation opening 160 and may protrude from the first storage part body 210 to pass through the first operation opening 160.

The second storage part 300 may include a second operation projection 380. The second operation projection 380 may be inserted into the second operation opening 170 and may protrude from the second storage part body 310 to pass through the second operation opening 170.

The heating device 10 may include a signal generator 15, a second switch 16, and a third switch 17. The signal generator 15 may be configured to generate a specific signal to a user. As an example, the signal may be a sound. In another example, the signal may be light that is emitted through a light emitting device. As another example, the signal generator 15 may generate sound and light simultaneously.

The second switch 16 may be disposed at a position corresponding to the first operation projection 260. When the second switch 16 is pressed by the first operation projection 260, it may operate the signal generator 15 to generate a signal after a first reference time period. The first reference time period may be 20 minutes, but the present disclosure is not limited thereto.

The third switch 17 may be disposed at a position corresponding to the second operation projection 380. When the third switch 17 is pressed by the second operation projection 380, it may operate the signal generator 15 to generate a signal after a second reference time period. The second reference time period may be a time of 7 minutes to 10 minutes.

Hereinafter, the operation of the reaction vessel system according to the first embodiment will be described in detail based on the above description. The contents described in the description of the reaction vessel will be omitted.

First, a user samples a sample by using a sampling tool.

Next, the user puts the sampled sample into the first storage part 200 and closes the first upper cover 230 to seal the first storage space 211.

Next, the user inserts the reaction vessel into the insertion space 11 of the heating device 10. In this case, the downward movement of the first storage part 200 may be allowed by the operation initiating projection 14. In addition, the heating part 12 may be operated by the first switch 13.

Next, the user moves the first storage part 200 downward. In this process, the second switch 16 is pressed, and after the first reference time period, the signal generator 15 generates a signal.

After the first reference time period, the user moves the second storage part 300 downward. In this process, the third switch 17 is pressed, and after the second reference time period, the signal generator 15 generates a signal.

Finally, the user may extract the reaction vessel and identify an inspection result through the exposure area 190.

### Second Embodiment

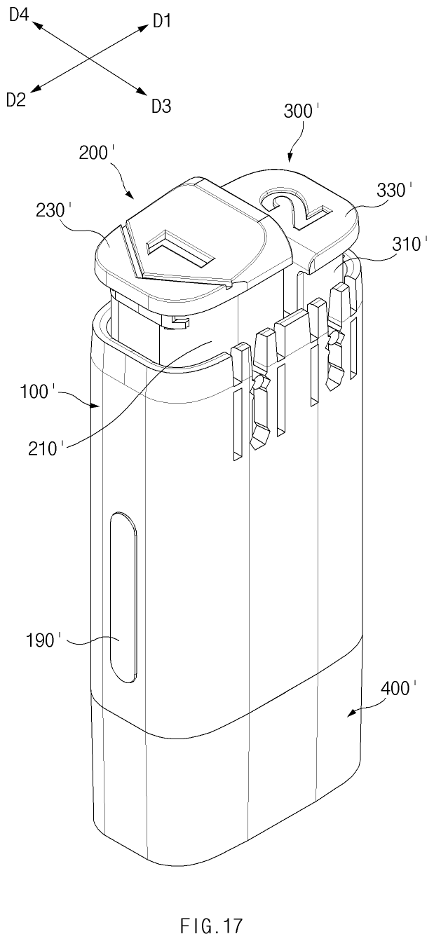

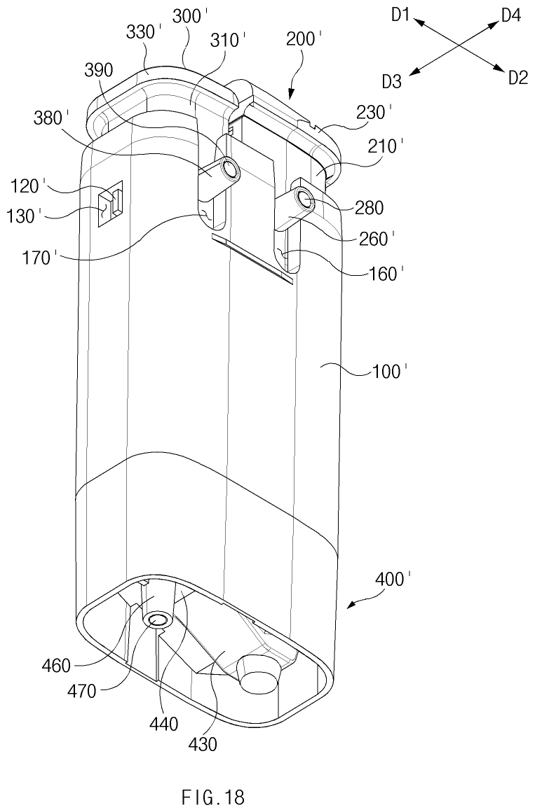

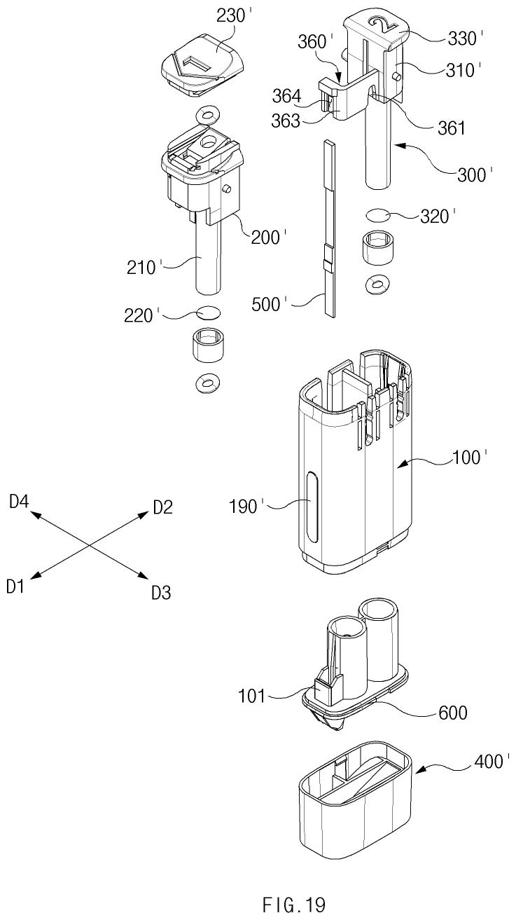

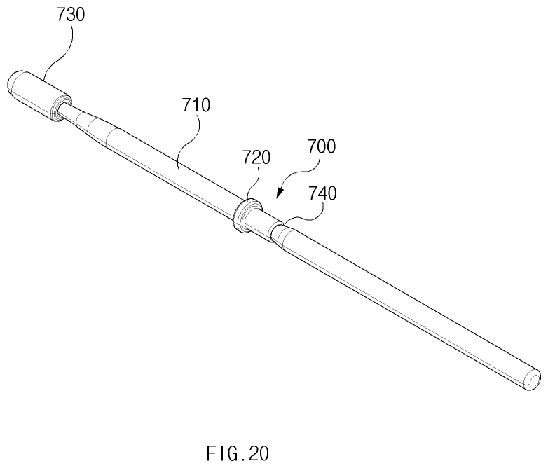

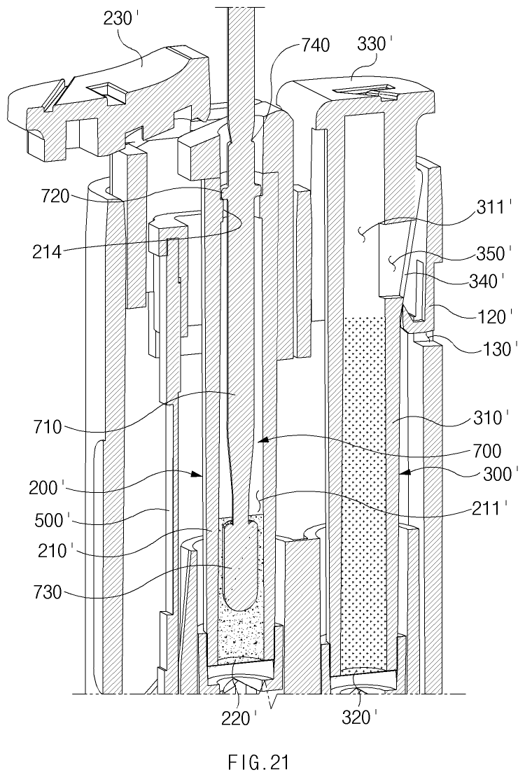

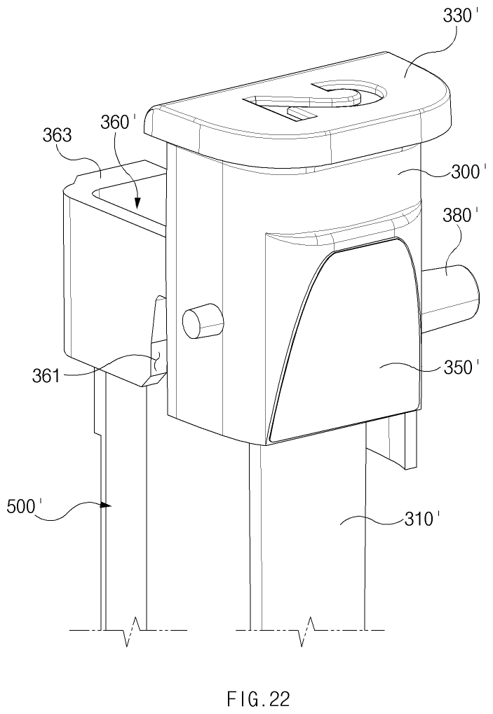

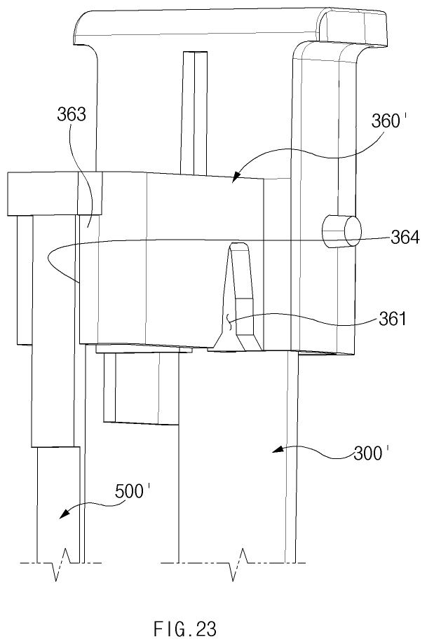

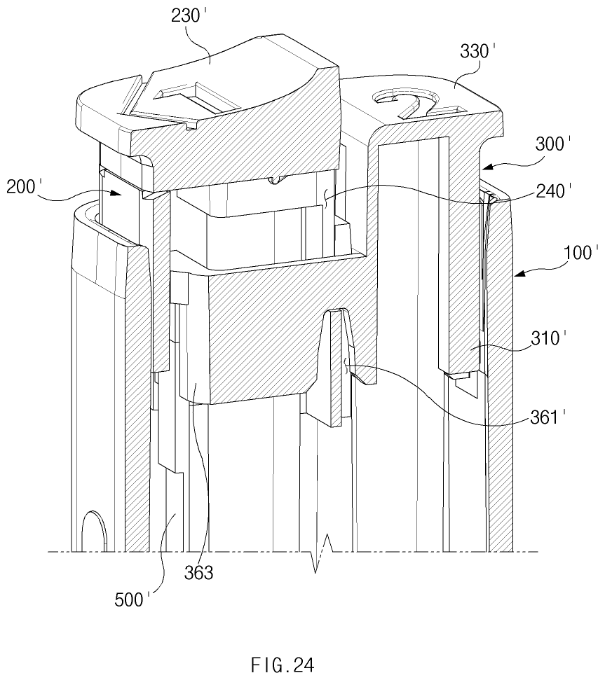

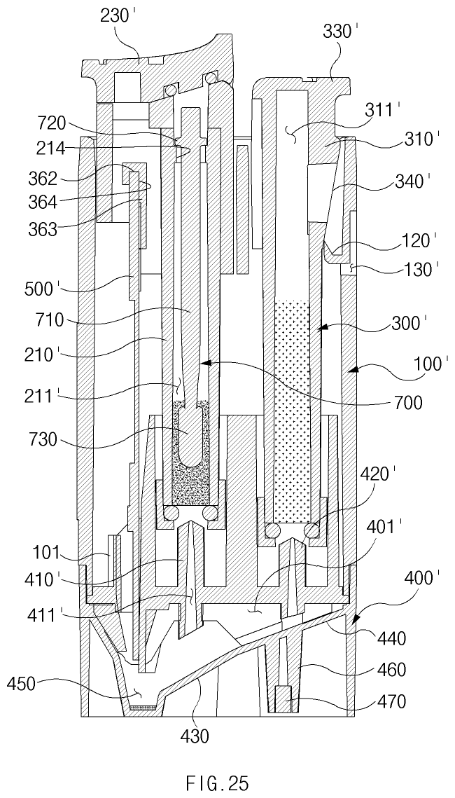

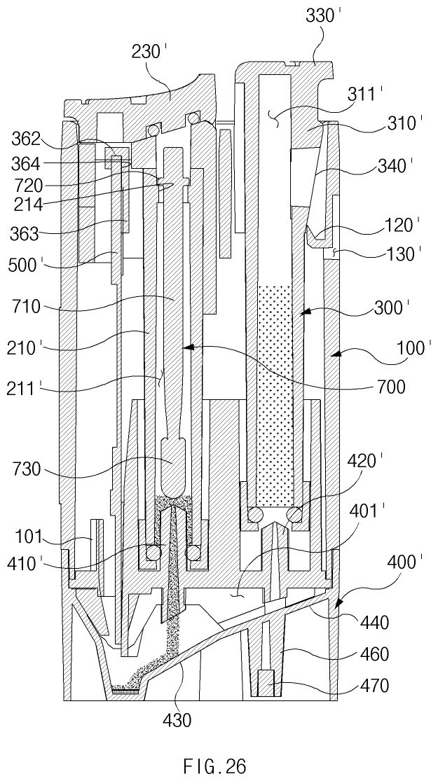

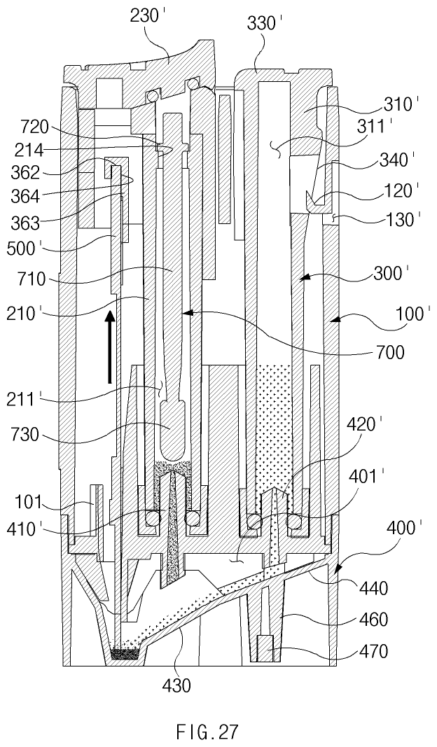

FIG. 17 is a perspective view illustrating a reaction vessel according to a second embodiment of the present disclosure. FIG. 18 is a view illustrating the reaction vessel of FIG. 17, viewed from a different direction. FIG. 19 is an exploded perspective view illustrating the reaction vessel according to the second embodiment of the present disclosure. FIG. 20 is a perspective view illustrating a swab FIG. 21 is a cross-sectional view illustrating a state, in which a swab is disposed in a first inner space of the reaction vessel according to the second embodiment of the present disclosure. FIG. 22 is a view illustrating a second storage part of the reaction vessel according to the second embodiment of the present disclosure. FIG. 23 is a view illustrating the second storage part of FIG. 22, viewed from a different direction. FIG. 24 is a view illustrating a first stopper opening and a second stopper opening together. FIG. 25 is a view illustrating a state before the first storage part and the second storage part are moved downward. FIG. 26 is a view illustrating a state, in which a first storage part is moved downward in FIG. 25. FIG. 27 is a view illustrating a state, in which a second storage part is moved downward in FIG. 26.

Hereinafter, a reaction vessel and a reaction vessel system according to a second embodiment of the present disclosure will be described with reference to FIGS. 17 to 27. The reaction vessel and the reaction vessel system according to the second embodiment are different from the reaction vessel and the reaction vessel system according to the first embodiment in a shape of the mixing part, shapes of an opening and an opening rupturing member, and an operation method of the heating device. The same or corresponding reference numerals are assigned to the same or corresponding configurations to those of the reaction vessel and the reaction vessel system according to the first embodiment, and a detailed description thereof will be omitted.

### Reaction Vessel

The reaction vessel according to the second embodiment of the present disclosure may include a body part 100′, a first storage part 200′, a second storage part 300′, and a mixing part 400′. An exposure area 190′ may be formed in the body part 100′.

The mixing part 400′ may include a first inclined portion 430 and a second inclined portion 440. The first inclined portion 430 may be formed to be inclined upward with respect to the first direction D1. The second inclined portion 440 may be formed to be inclined upward with respect to the first direction D1 and may be located in the first direction D1 of the first inclined portion 430. An inclination of the second inclined portion 440 may be smaller than that of the first inclined portion 430.

This may mean that liquid that flows along the second inclined portion 440 flows toward the first inclined portion 430. Furthermore, this may mean that a speed, at which the liquid flows along the second inclined portion 440, is lower than a speed, at which the liquid flows along the first inclined portion 430.

A reaction solution that is disposed in the first storage space 211′ may have a higher viscosity than a developer solution that is disposed in the second storage space 311′. Accordingly, an inclination of the first inclined portion 430 may be formed to be steeper than that of the second inclined portion 440 so that a reaction solution is more smoothly guided to a sample.

When viewed along the upward/downward directions, the first inclined portion 430 may include an area that overlaps the first storage part 200′. This may mean that the first inclined portion 430 is a portion, on which the reaction solution that has dropped from the first storage space 211′ is seated.

The second inclined portion 440 may include an area that overlaps the second storage part 300′. This may mean that the second inclined portion 440 is a portion, on which the developer solution that has dropped from the second storage space 311′ is seated.

The mixing part 400′ may further include a mixing opening 450. The mixing opening 450 may communicate with the mixing space 401′, may be located on an opposite side to the first direction D1 of the first inclined portion 430, and may be a portion that is opened upward. A buffer solution may be disposed in an interior of the mixing opening 450. The mixing opening 450 may be a portion, at which the sample, the reaction solution, the buffer solution, and the developer solution are collected. Furthermore, the mixing opening 450 may be a portion, at which a lower end portion of the reaction detection part 500′ is disposed when the reaction detection part 500′ is moved downward.

The mixing part 400′ may further include a first rupturing member 410′ and a second rupturing member 420′. When viewed along the upward/downward directions, the first inclined portion 430 may include an area that overlaps the first rupturing member 410′. Furthermore, when viewed along the upward/downward directions, the second inclined portion 440 may include an area that overlaps the second rupturing member 420′.

A waterproof member 600 for waterproofing may be disposed between the first storage part 200′ and the mixing part 400′, and between the second storage part 300′ and the mixing part 400′. As an example, the waterproof member 600 may be a waterproof tape. This may be to prevent contents from leaking between the first storage part 200′ and the mixing part 400′, or between the second storage part 300′ and the mixing part 400′.

The first storage part 200′ of the reaction vessel according to the second embodiment may include a first storage part body 210′ and a first lower cover 220′.

The first storage part 200′ may further include a first interference part 214. The first interference part 214 may protrude from an interior surface of the first storage part body 210′ toward the first storage space 211′. The first interference part 214 may be a portion that is configured to interfere with an entry of a sampling tool that is introduced into the first storage space 211′.

As an example, the sampling tool may be a swab 700. The swab 700 may include a swab body 710 that extends along an extension direction thereof, a swab protrusion 720, and a sampling part 730. The swab protrusion 720 may protrude outward from the swab body 710. The sampling part 730 may be coupled to an end of the swab body 710 in an opposite direction to the extension direction thereof.

Furthermore, a cutaway part 740 may be formed in the swab body 710. The cutaway part 740 may be formed at a side of the swab protrusion 720 in an extension direction thereof. A distance between the cutaway part 740 and the swab protrusion 720 may be smaller than a distance between the swab protrusion 720 and the sampling part 730.

When the swab 700 is inserted into the first storage space 211′, a portion of the swab body 710, which is located at a side of the cutaway part 740 in an extension direction thereof, may be cut. As an example, in a process of moving the first upper cover 230′ in the first direction D1, the first upper cover 230′ may press the swab body 710, and a portion of the swab body 710, which is located at a side of the cutaway part 740 in an extension direction thereof, may be cut. In another method, before a user moves the first upper cover 230′ in the first direction D1, the swab body 710 may be cut by applying a force to the swab body 710.

The first storage space 211′ may include an upper space that is located on an upper side of the first interference part 214 and a lower space that is located on a lower side of the first interference part 214. A length of the upper space in the upward/downward directions may be smaller than a length of the lower space in the upward/downward directions. The upper space may be a space, in which an area between the swab protrusion 720 and the cutaway part 740 is disposed. The lower space may be a space, in which an area between the sampling part 730 and the swab protrusion 720 is disposed.

The first interference part 214 may prevent the first rupturing member 410′ from being contacted to block the first introduction space 411′ as the sampling part 730 enters excessively deep due to interference with movement of the swab protrusion 720.

The second storage part 300′ of the reaction vessel according to the second embodiment may include a second storage part body 310′, a second lower cover 320′, and a second upper cover 330′.

The second storage part 300′ may further include an opening 340′ and an opening cover 350′. The body part 100′ of the reaction vessel according to the second embodiment may include an opening rupturing member 120′.

The opening 340′ may be formed in a side wall of the second storage part body 310′ and may have a shape that is inclined upward with respect to the first direction D1. When viewed along the upward/downward directions, an end of the opening rupturing member 120′ and the opening cover 350′ may overlap each other. The end of the opening rupturing member 120′ may be formed to face an upper side. The opening rupturing member 120 may be disposed in the communication opening 340′.

When viewed along the upward/downward directions, the end of the opening rupturing member 120′ and the opening cover 350′ overlap each other, so that, when the second storage part 300′ is moved downward, the end of the opening rupturing member 120′ may contact the opening cover 350′, and the opening rupturing member 120′ may rupture the opening cover 350′.

The first storage part 200′ may further include a first stopper opening 240′. The first stopper opening 240′ may be formed in the first storage part body 210′, may be opened upward, and may be open along the first direction D1.

The second storage part 300′ may further include a stopper member 360′. The stopper member 360′ may protrude from the second storage part body 310′ and may pass through the first stopper opening 240′ along an opposite direction to the first direction D1. The stopper member 360′ may be a component for interfering with the downward movement of the second storage part 300′ before the first storage part 200′ is moved downward.

A first stopper opening 361 may be formed in the stopper member 360′. The first stopper opening 361 may be opened downward and may be open along a direction that is perpendicular to the first direction D1. At least any one of when the first storage part 200′ and the second storage part 300′ are located at an uppermost end and when the first storage part 200′ and the second storage part 300′ are located at a lowermost end, an area of the first storage part body 210′ that defines the first stopper opening 240′ and an area of the stopper member 360′ that defines the first stopper opening 361 may be engaged with each other.

Because an area of the first storage part body 210′ that defines the first stopper opening 240′ and an area of the stopper member 360′ that defines the first stopper opening 361 are engaged with each other, movement of the second storage part 300′ along the first direction D1 or the second direction D2 with respect to the first storage part 200′ may be interfered with, and movement of the first storage part 200′ along the third direction D3 or the fourth direction D4 with respect to the second storage part 300′ may be interfered with.

The reaction vessel may further include a reaction detection part 500′. An upper end portion of the reaction detection part 500′ may be fitted into a fitting opening 362. The fitting opening 362 may be formed in a fitting area 363 that is an area of the stopper member 360′ located on the second direction D2 of the first storage part 200′. The fitting opening 362 may be opened downward. A length of the fitting opening 362 in the second direction D2 may be equal to or less than a length of the reaction detection part 500′ in the second direction D2. This may be for interference fitting of the reaction detection part 500′.

The fitting area 363 may further include a disposition opening 364. The disposition opening 364 may be an opening 340′ that is opened toward the second direction D2, and in which the reaction detection part 500′ is disposed.

The body part 100′ may further include a through portion 101. The through portion 101 may be a portion that is opened upward and downward and is configured to surround a portion of the reaction detection part 500′. The through portion 101 may be a structure that guides upward and downward movement of the reaction detection part 500′.

Hereinafter, a structure for interaction with a heating device 10′ according to a second embodiment to be described later will be described in detail.

The body part 100′ may include a first operation opening 160′ and a second operation opening 170′. The first storage part 200′ may include a first operation projection 260′ and a first magnet 280. The first magnet 280 may be coupled to an end of the first operation projection 260′. The first magnet 280 may be a member that may be sensed by a second sensing member 16′ that will be described later.

The second storage part 300′ may include a second operation projection 380′ and a second magnet 390. The second magnet 390 may be coupled to an end of the second operation projection 380′. The second magnet 390 may be a member that may be sensed by a third sensing member 17′ that will be described later.

Furthermore, the reaction vessel may further include an operation projection 460 and an operation magnet 470. The operation projection 460 may protrude downward from a lower surface of the mixing part 400′. The operation magnet 470 may be coupled to an end of the operation projection 460. The operation magnet 470 may be a member that may be sensed by a first sensing member 13′ that will be described later.

Hereinafter, the operation of the reaction vessel according to the second embodiment of the present disclosure will be described conceptually with reference to the above description and the drawings. Hereinafter, a case, in which the sampling tool is a swab 700, will be described in detail.

First, a user samples a sample by using the swab 700, moves the first upper cover 230′ in the second direction D2, and inserts the swab 700 into the first storage space 211′. The sampling part 730 contacts the reaction solution, and the swab protrusion 720 is stopped by the first interference part 214. The sample may react with the reaction solution.

Next, a user moves the first upper cover 230′ in the first direction D1. In this process, an external force may be applied to the cutaway part 740, so that the swab body 710 may be cut.

Next, the user moves the first storage part 200′ downward. In this process, the first lower cover 220′ is ruptured, and the reaction solution in the first storage space 211′ and the sample are moved to the mixing space 401′, and are seated on the first inclined portion 430. The reaction solution and the sample seated on the first inclined portion 430 are moved along the inclination to the mixing opening 450. In this process, the buffer solution in the mixing space 401′, the reaction solution, and the sample may be mixed. This may be a state as in FIG. 26.

Next, the user moves the second storage part 300′ downward. In this process, the second lower cover 320′ and the opening cover 350′ are ruptured, the developer solution in the second storage space 311′ is moved to the mixing space 401′, and is seated on the second inclined portion 440. The developer solution seated on the second inclined portion 440 is moved along the inclination, via the first inclined portion 430, to the mixing opening 450, so that a reaction mixture may be formed. In this process, the reaction detection part 500′ is moved downward together with the second storage part 300′, so that the reaction detection part 500′ contacts the reaction mixture located in the mixing opening 450 whereby a reaction may be detected. This may be a state as in FIG. 27.

As an example, the above-described operations may be performed before the reaction vessel is inserted into an insertion space 11′ of the heating device 10′.

### Heating Device 10′

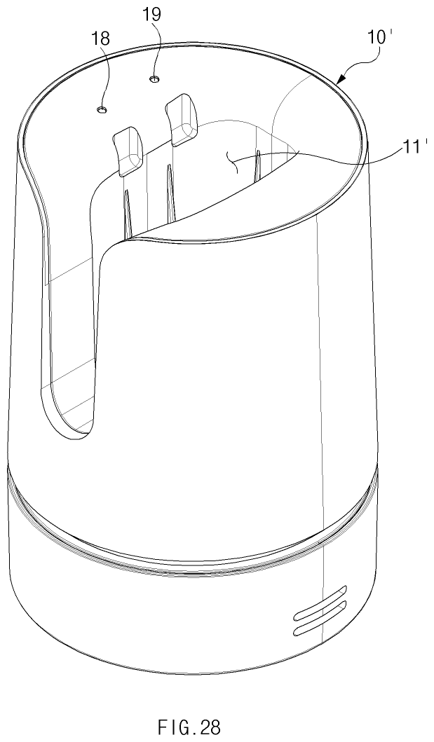

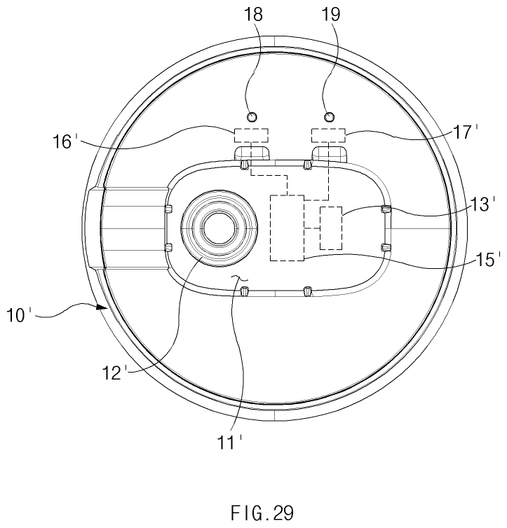

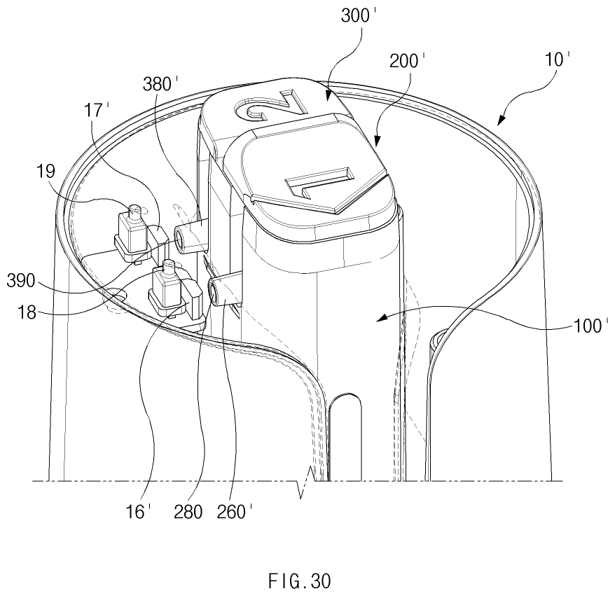

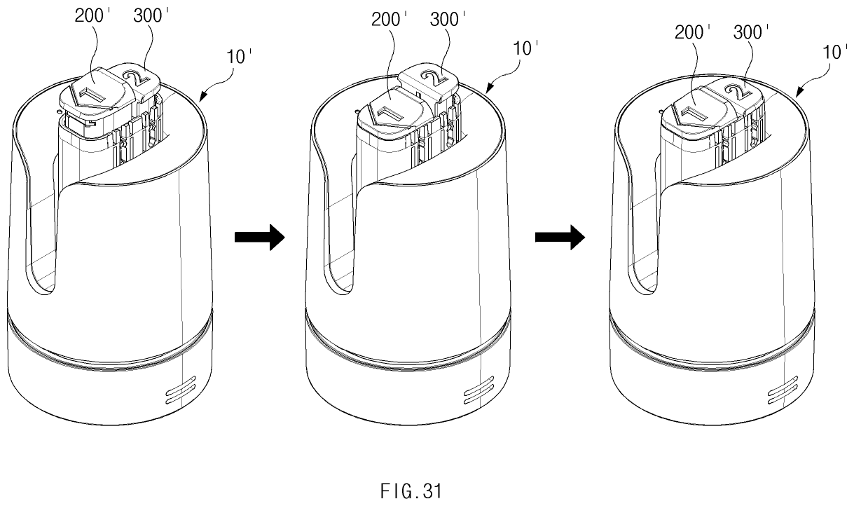

Hereinafter, a heating device 10′ according to a second embodiment will be described in detail with reference to FIGS. 28 to 31. FIG. 28 is a view illustrating a heating device according to the second embodiment of the present disclosure. FIG. 29 is a view illustrating a heating device according to the second embodiment of the present disclosure, viewed from a top. FIG. 30 is a view illustrating a state, in which the reaction vessel is disposed in an interior of the heating device according to the second embodiment of the present disclosure. FIG. 31 is a view sequentially illustrating operation procedures of a reaction vessel system according to the second embodiment of the present disclosure. For reference, in FIG. 30, a portion of the heating device 10′ is illustrated in a transparent view for convenience of description.

The heating device 10′ may include a heating part 12′. The heating part 12′ may be configured to contact an area of the mixing part 400′ that defines the mixing opening 450 to heat the mixing opening 450. By heating the mixing opening 450, a buffer solution in a frozen state may be thawed.

The heating part 12′ may include a temperature sensor. The temperature sensor may be configured to measure a temperature of the heating part 12′. The heating part 12′ may be configured to maintain a reference temperature based on a temperature measured by the temperature sensor. As an example, the reference temperature may be 60° C. to 70° C.

The heating device 10′ may include a signal generator 15′. After the heating part 12′ completes preheating for a specific time, the signal generator 15′ may generate a signal to insert the reaction vessel into the insertion space 11′.

The heating part 12′ may include a first sensing member 13′. The first sensing member 13′ may sense the operation magnet 470 when the reaction vessel is inserted into the insertion space 11′. As an example, the first sensing member 13′ may sense the operation magnet 470 based on an induced current that is generated as the operation magnet 470 becomes closer or more distant. The first sensing member 13′ may operate the signal generator 15′ to generate a signal to move the first storage part 200′ downward when sensing the operation magnet 470.

Furthermore, the first sensing member 13′ may operate the signal generator 15′ to generate a signal to prompt a user to reinsert the reaction vessel when sensing that the operation magnet 470 has been removed.

The heating part 12′ may include a second sensing member 16′. The second sensing member 16′ may be disposed at a position corresponding to the first operation projection 260′ and may operate the signal generator 15′ to generate a signal after a first reference time period when sensing the first magnet 280. The signal at this time may be a signal to move the second storage part 300′ downward. As an example, the second sensing member 16′ may sense the first magnet 280 based on an induced current that is generated as the first magnet 280 becomes closer or more distant.

The heating part 12′ may include a third sensing member 17′. The third sensing member 17′ may be disposed at a position corresponding to the second operation projection 380′ and may operate the signal generator 15′ to generate a signal after a second reference time period when sensing the second magnet 390. The signal at this time may be a signal indicating that the inspection has been completed.

As an example, the third sensing member 17′ may sense the second magnet 390 based on an induced current that is generated as the second magnet 390 becomes closer or more distant.

The heating part 12′ may include a first light emitting member 18 and a second light emitting member 19. The first light emitting member 18 may be turned on when the first sensing member 13′ senses the operation magnet 470. The first light emitting member 18 may be turned off after the second sensing member 16′ senses the first magnet 280. The first light emitting member 18 may be disposed adjacent to the second sensing member 16′.

The second light emitting member 19 may be turned on after the first reference time period elapses following the second sensing member 16′ sensing the first magnet 280. The second light emitting member 19 may be turned off after the third sensing member 17′ senses the second magnet 390. The second light emitting member 19 may be disposed adjacent to the third sensing member 17′.

As an example, the signal generator 15′, the first light emitting member 18, and the second light emitting member 19 may be electrically connected to the first sensing member 13′, the second sensing member 16′, and the third sensing member 17′ through a controller.

Hereinafter, the operation of the reaction vessel system according to the second embodiment will be described in detail based on the above description. The contents described in the description of the reaction vessel will be omitted.

First, a user samples the sample by using the swab 700.

Next, the user puts the sampled sample into the first storage part 200′ and closes the first upper cover 230′ to seal the first storage space 211′.

Next, a user connects a power source to the heating device 10′. In this case, the heating part 12′ may be operated so that the heating part 12′ is preheated. However, a process of connecting power to the heating device 10′ and preheating it may be performed before a process of sampling the sample.

Next, the user inserts the reaction vessel into the insertion space 11′ of the heating device 10′. Accordingly, the heating part 12′ heats the buffer solution located in the mixing opening 450 to thaw it. In this case, the first sensing member 13′ may sense the operation magnet 470. The first sensing member 13′ may operate the signal generator 15′ to generate a signal to move the first storage part 200′ downward when sensing the operation magnet 470.

Next, the user moves the first storage part 200′ downward. In this process, the second sensing member 16′ may sense the first magnet 280 and may operate the signal generator 15′ to generate a signal to move the second storage part 300′ downward after a first reference time period.

Next, the user moves the second storage part 300′ downward. In this process, the third sensing member 17′ may sense the second magnet 390 and may operate the signal generator 15′ to generate a signal indicating that the inspection has been completed after a second reference time period.

Finally, the user may extract the reaction vessel and identify an inspection result through the exposure area 190′.

The above description is merely an example of the technical idea of the present disclosure, and various modifications and variations may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

1. A reaction vessel comprising:
a body part;
a first storage part disposed in the body part, being movable upward and downward, and including a first storage space in an interior thereof;
a second storage part disposed in the body part, being movable upward and downward, including the second storage part in an interior thereof, and disposed in a first direction being one of leftward/rightward directions with respect to the first storage part;
a mixing part including a mixing space communicating with the first storage space when the first storage part is located at a lowermost end thereof, and communicating with a second storage space when the second storage part is located at the lowermost end thereof; and
a reaction detection part configured to react with a reaction mixture located in the mixing space to exhibit a detection reaction after the lower end portion contacts the reaction mixture.

2. The reaction vessel of claim 1, wherein the first storage part includes:
a first storage part body defining the first storage space opened upward and downward; and
a first lower cover coupled to a lower side of the first storage part body and covering a lower side of the first storage space,
wherein the mixing part includes:
a first rupturing member defining a first introduction space communicating with the mixing space and extending to an upper side of the mixing space, and
wherein the first rupturing member is configured to rupture the first lower cover when the first storage part is moved downward to allow the first storage space and the first introduction space to communicate with each other.

3. The reaction vessel of claim 1, wherein the first storage part further includes
a first storage part body defining the first storage space opened upward and downward; and
a first upper cover coupled to an upper side of the first storage part body and configured to open and close an upper side of the first storage space.

4. The reaction vessel of claim 3, wherein an upper side of the first storage part body is formed to be inclined upward with respect to the first direction, and
wherein the first upper cover has a shape corresponding to the upper side of the first storage part body.

5. The reaction vessel of claim 4, wherein the first upper cover is coupled to the upper side of the first storage part body to be slid leftward and rightward, opens the upper side of the first storage space when being moved in a second direction opposite to the first direction, and closes the upper side of the first storage space when being moved in the first direction.

6. The reaction vessel of claim 2, wherein the second storage part includes:
a second storage part body defining the second storage space opened upward and downward; and
a second lower cover coupled to a lower side of the second storage part body and covering a lower side of the second storage space,
wherein the mixing part includes:
a second rupturing member defining a second introduction space communicating with the mixing space and extending to the upper side of the mixing space, and
wherein the second rupturing member is configured to rupture the second lower cover when the second storage part is moved downward to allow the second storage space and the second introduction space to communicate with each other.

7. The reaction vessel of claim 6, wherein the second storage part further includes:
an opening formed at an upper portion of the second storage part body; and
an opening cover configured to close the opening, and
wherein the body part includes:
an opening rupturing member configured to rupture the opening cover to open the opening when the second storage part is moved downward.

8. The reaction vessel of claim 7, wherein the opening is formed in a side wall of the second storage part body,
wherein the opening rupturing member contacts a lower surface of an area of the second storage part body defining the opening to support the second storage part body upward,
wherein a surface of the opening rupturing member contacting the second storage part body is formed to be an inclined surface, and
wherein when the second storage part body is moved downward, an end of the opening rupturing member facing the second storage part body is moved to contact the second storage part body so as to contact the opening cover after elastically supporting the second storage part body.

9. The reaction vessel of claim 7, wherein the body part further includes:
a communication opening formed in a wall corresponding to a position of the opening when the second storage part body is moved downward, and
wherein the opening rupturing member is disposed in the communication opening.

10. The reaction vessel of claim 1, wherein the first storage part includes:
a first storage part body defining the first storage space opened upward and downward; and
a stopper opening formed in the first storage part body and opened upward, and
wherein the second storage part includes:
a second storage part body defining the second storage space opened upward and downward; and
a stopper member protruding from the second storage part body and passing through the stopper opening.

11. The reaction vessel of claim 10, wherein the reaction detection part is connected to the second storage part by the stopper member to be moved upward and downward, and is disposed in a second direction of the first storage part being opposite to the first direction.

12. The reaction vessel of claim 1, wherein the body part includes:
a first guide opening formed in a side wall of the body part in a third direction perpendicular to the upward/downward directions and the first direction; and
a second guide opening located in the first direction of the first guide opening and opened upward,
wherein the first storage part includes:
a first storage part body defining the first storage space opened upward and downward; and
a first guide projection protruding from the first storage part body in the third direction and inserted into the first guide opening, and
wherein the second storage part includes:
a second storage part body defining the second storage space opened upward and downward; and
a second guide projection protruding from the second storage part body in the third direction and inserted into the second guide opening.

13. The reaction vessel of claim 12, wherein the first guide opening includes:
a first interference area having a width smaller than a diameter of the first guide projection, and configured to interfere with downward movement of the first guide projection, and
wherein the second guide opening includes:
a second interference area having a width smaller than a diameter of the second guide projection, and configured to interfere with downward movement of the second guide projection.

14. The reaction vessel of claim 1, wherein an operation preventing opening opened upward is formed in a side wall of the body part,
wherein the first storage part includes:
a first storage part body defining the first storage space opened upward and downward; and
an operation preventing member protruding from the first storage part body and seated in the operation preventing opening, and
wherein the operation preventing member includes:
a first part protruding from the first storage part body toward the side wall of the body part; and
a second part protruding downward from the first part and seated in the operation preventing opening.

15. The reaction vessel of claim 1, wherein a surface of the mixing part defining a lower side of the mixing space is formed to be inclined upward with respect to the first direction.

16. The reaction vessel of claim 1, wherein a freeze-dried buffer solution is disposed in the mixing space,
wherein a reaction solution configured to react with a sample sampled from a user is disposed in the first storage space,
wherein a developer solution configured to develop the reaction solution mixed with the buffer solution to the reaction detection part is disposed in the second storage space, and
wherein the buffer solution includes:
an enzyme and a primer.

17. A reaction vessel system comprising:
a reaction vessel; and
a heating device configured such that the reaction vessel is inserted into an insertion space in an interior thereof, and configured to heat a lower side of the reaction vessel,
wherein the reaction vessel includes:
a body part;
a first storage part disposed in the body part, being movable upward and downward, and including a first storage space in an interior thereof;
a second storage part disposed in the body part, being movable upward and downward, and including a second storage space in an interior thereof; and
a mixing part including a mixing space communicating with the first storage space when the first storage part is located at a lowermost end thereof, and communicating with the second storage space when the second storage part is located at the lowermost end thereof.

18. The reaction vessel system of claim 17, wherein the heating device includes:
a heating part configured to heat the mixing space while contacting a lower side of the mixing part; and
a first switch configured to be pressed by a lower side of the reaction vessel to operate the heating part when the reaction vessel is inserted into the insertion space.

19. The reaction vessel system of claim 18, wherein an operation preventing opening opened upward is formed in a side wall of the body part, wherein the first storage part includes:
a first storage part body defining the first storage space opened upward and downward; and
an operation preventing member protruding from the first storage part body and seated in the operation preventing opening,
wherein the operation preventing member includes:
a first part protruding from the first storage part body toward the side wall of the body part; and
a second part protruding downward from the first part and seated in the operation preventing opening, and
wherein the heating device includes:
an operation initiating projection protruding from a surface defining the insertion space toward the second part, and configured to press the second part to separate the second part from the operation preventing opening when the reaction vessel is moved downward.

20. The reaction vessel system of claim 18, wherein the body part includes:
a first operation opening opened upward; and
a second operation opening opened upward,
wherein the first storage part includes:
a first storage part body defining the first storage space opened upward and downward; and
a first operation projection inserted into the first operation opening and protruding from the first storage part body to pass through the first operation opening,
wherein the second storage part includes:
a second storage part body defining the second storage space opened upward and downward; and
a second operation projection inserted into the second operation opening and protruding from the second storage part body to pass through the second operation opening, and
wherein the heating device includes:
a signal generator configured to generate a specific signal to a user;
a second switch disposed at a position corresponding to the first operation projection, and configured to operate the signal generator such that the signal generator generates the signal after a first reference time period when being pressed by the first operation projection; and
a third switch disposed at a position corresponding to the second operation projection, and configured to operate the signal generator such that the signal generator generates the signal after a second reference time period when being pressed by the second operation projection.

21. A reaction vessel comprising:
a body part;
a first storage part disposed in the body part, being movable upward and downward, and including a first storage space in an interior thereof;
a second storage part disposed in the body part, being movable upward and downward, including a second storage part in an interior thereof, and disposed in a first direction being one of leftward/rightward directions with respect to the first storage part; and
a mixing part including a mixing space communicating with the first storage space when the first storage part is located at a lowermost end thereof, and communicating with the second storage space when the second storage part is located at the lowermost end thereof,
wherein the mixing part includes:
a first inclined portion formed to be inclined upward with respect to the first direction; and
a second inclined portion formed to be inclined upward with respect to the first direction and located in the first direction of the first inclined portion, and an inclination degree of which is smaller than that of the first inclined portion.

22. The reaction vessel of claim 21, wherein when viewed along upward/downward direction,
the first inclined portion includes an area overlapping the first storage part, and
the second inclined portion includes an area overlapping the second storage part.

23. The reaction vessel of claim 21, wherein the first storage part includes:
a first storage part body defining the first storage space opened upward and downward; and
a first lower cover coupled to a lower side of the first storage part body and covering a lower side of the first storage space,
wherein the mixing part includes:
a first rupturing member defining a first introduction space communicating with the mixing space and extending to an upper side of the mixing space, and
wherein the first rupturing member is configured to rupture the first lower cover when the first storage part is moved downward to allow the first storage space and the first introduction space to communicate with each other.

24. The reaction vessel of claim 23, wherein the first storage part further includes
a first interference part protruding from an inner surface of the first storage part body toward the first storage space, and configured to interfere with an entry of a sampling tool introduced into the first storage space.

25. The reaction vessel of claim 24, wherein the first storage space includes:
an upper space located on an upper side of the first interference part; and
a lower space located on a lower side of the first interference part, and
wherein a length of the upper space in upward/downward directions is smaller than a length of the lower space in the upward/downward directions.

26. The reaction vessel of claim 23, wherein the second storage part includes:
a second storage part body defining the second storage space opened upward and downward; and
a second lower cover coupled to a lower side of the second storage part body and covering a lower side of the second storage space,
wherein the mixing part includes:
a second rupturing member defining a second introduction space communicating with the mixing space and extending to the upper side of the mixing space, and
wherein the second rupturing member is configured to rupture the second lower cover when the second storage part is moved downward to allow the second storage space and the second introduction space to communicate with each other.

27. The reaction vessel of claim 26, wherein the second storage part further includes:
an opening formed at an upper portion of the second storage part body; and
an opening cover configured to close the opening, and
wherein the body part includes:
an opening rupturing member configured to rupture the opening cover when the second storage part is moved downward.

28. The reaction vessel of claim 27, wherein the opening is formed in a side wall of the second storage part body and has a shape inclined upward with respect to the first direction, and
wherein when viewed along the upward/downward direction, an end of the opening rupturing member and the opening cover overlap each other.

29. The reaction vessel of claim 28, wherein an end of the opening rupturing member faces an upper side.

30. The reaction vessel of claim 26, wherein the first storage part further includes
a first stopper opening formed in the first storage part body, opened upward, and opened along the first direction, and
wherein the second storage part includes:
a stopper member protruding from the second storage part body, and passing through the first stopper opening along an opposite direction of the first direction.

31. The reaction vessel of claim 30, wherein a second stopper opening opened downward and opened along a direction perpendicular to the first direction is formed in the stopper member, and
wherein at least any one of when the first storage part and the second storage part are located at an uppermost end or the first storage part and the second storage part are located at a lowermost end, an area of the first storage part body defining the first stopper opening and an area of the stopper member defining the second stopper opening are engaged with each other.

32. The reaction vessel of claim 30, further comprising:
a reaction detection part configured to react with a reaction mixture located in the mixing space to exhibit a detection reaction after the lower end portion contacts the reaction mixture,
wherein the reaction detection part is formed in a fitting area of the first storage part of the stopper member located in a second direction opposite to the first direction, and an upper end portion thereof is fitted in a fitting opening opened downward.

33. The reaction vessel of claim 32, wherein the fitting area further includes:
a disposition opening opened toward the second direction, and in which the reaction detection part is disposed in an interior thereof.

34. The reaction vessel of claim 32, wherein the body part further includes: a through portion opened upward and downward, and configured to surround a portion of the reaction detection part.

35. The reaction vessel of claim 21, wherein the body part includes:
a first operation opening opened upward; and
a second operation opening opened upward and located in the first direction of the first operation opening,
wherein the first storage part includes:
a first storage part body defining the first storage space opened upward and downward;
a first operation projection inserted into the first operation opening and protruding from the first storage part body to pass through the first operation opening; and
a first magnet coupled to an end of the first operation projection, and
wherein the second storage part includes:
a second storage part body defining the second storage space opened upward and downward;
a second operation projection inserted into the second operation opening and protruding from the second storage part body to pass through the second operation opening; and
a second magnet coupled to an end of the second operation projection,

36. The reaction vessel of claim 21, further comprising:
an operation projection protruding downward from a lower surface of the mixing part; and
an operation magnet coupled to an end of the operation projection.

37. The reaction vessel of claim 21, wherein the mixing part further includes:
a mixing opening communicating the mixing space, located in an opposite direction of the first direction of the first inclined portion, and opened upward.

38. A reaction vessel system comprising:
a reaction vessel; and
a heating device configured such that the reaction vessel is inserted into an insertion space in an interior thereof, and configured to heat a lower side of the reaction vessel,
wherein the reaction vessel includes:
a body part;
a first storage part disposed in the body part, being movable upward and downward, and including a first storage space in an interior thereof;
a second storage part disposed in the body part, being movable upward and downward, including a second storage part in an interior thereof, and disposed in a first direction being one of leftward/rightward directions with respect to the first storage part; and
a mixing part a mixing space communicating with the first storage space when the first storage part is located at a lowermost end thereof, and communicating with the second storage space when the second storage part is located at the lowermost end thereof, and
wherein the mixing part includes:
a first inclined portion formed to be inclined upward with respect to the first direction; and
a second inclined portion formed to be inclined upward with respect to the first direction, and located in the first direction of the first inclined portion, and an inclination degree of which is smaller than that of the first inclined portion.

39. The reaction vessel system of claim 38, further comprising:
an operation projection protruding downward from a lower surface of the mixing part; and
an operation magnet coupled to an end of the operation projection,
wherein the mixing part includes:
a mixing opening communicating the mixing space, located in an opposite direction of the first direction of the first inclined portion, and opened upward, and
wherein the heating device includes:
a heating part contacting an area of the mixing part defining the mixing opening and configured to heat the mixing opening; and
a first sensing member configured to sense the operation magnet when the reaction vessel is inserted into the insertion space.

40. The reaction vessel system of claim 39, wherein the body part includes:
a first operation opening opened upward; and
a second operation opening opened upward and located in the first direction of the first operation opening,
wherein the first storage part includes:
a first storage part body defining the first storage space opened upward and downward;
a first operation projection inserted into the first operation opening and protruding from the first storage part body to pass through the first operation opening; and
a first magnet coupled to an end of the first operation projection,
wherein the second storage part includes:
a second storage part body defining the second storage space opened upward and downward;
a second operation projection inserted into the second operation opening and protruding from the second storage part body to pass through the second operation opening; and
a second magnet coupled to an end of the first operation projection, and
wherein the heating device further includes:
a signal generator configured to generate a specific signal to a user;
a second sensing member disposed at a position corresponding to the first operation projection, and configured to operate the signal generator to generate the signal after a first reference time period when detecting the first magnet; and a third sensing member disposed at a position corresponding to the second operation projection, and configured to operate the signal generator to generate the signal after a second reference time period when detecting the second magnet.
